(19) United States
(12) Patent Application Publication
(10) Pub. No.: US 2011/0295739 A1
(43) Pub. Date: Dec. 1, 2011

(54) BANKRUPTCY PAYMENT AND DEBT TRACKING

(75) Inventors: Rhoena Regena Rice, Rhome, TX (US); Cynthia A. Mech, Lancaster, NY (US); Kelly Sue May, Simi Valley, CA (US); John Singleton Smith, Fort Worth, TX (US); LuAnne Marie Polak, Lancaster, NY (US)

(73) Assignee: BANK OF AMERICA CORPORATION, Charlotte, NC (US)

(21) Appl. No.: 12/787,982

(22) Filed: May 26, 2010

(51) Int. Cl. G06Q 40/00

(52) U.S. Cl. 705/39

(57) ABSTRACT

In general terms, embodiments of the present invention relate to methods and apparatuses for tracking payments and debts associated with a bankruptcy debtor. For example, some embodiments of the present invention are configured to: (a) receive information associated with one or more payments, where the one or more payments are associated with a debtor; (b) determine that a first portion of the one or more payments applies to pre-petition debt associated with the debtor; (c) determine that a second portion of the one or more payments applies to post-petition debt associated with the debtor; and (d) post, to a network-accessible account associated with the debtor, information that indicates that the first portion applies to the pre-petition debt and information that indicates that the second portion applies to the post-petition debt.

### FIELD

In general terms, embodiments of the present invention relate to methods and apparatuses for tracking payments and debts associated with a bankruptcy debtor.

### BACKGROUND

Chapter 13 of the United States Bankruptcy Code enables individuals with regular income to undergo a financial reorganization that is supervised by a federal bankruptcy court. When the debtor files for bankruptcy protection under this chapter, the debtor typically submits a payment plan to the court that outlines the installment payments the debtor will make to his or her creditors over the course of the plan period, which is usually three to five years in duration. In return for the debtor repaying his or her creditors over the plan period, the law forbids those creditors from initiating or continuing any collection efforts for debt incurred by the debtor prior to the bankruptcy filing. In addition, Chapter 13 protection typically enables the debtor to stop foreclosure proceedings against the debtor's home, as well as cure any of the debtor's delinquent home mortgage payments over the course of the Chapter 13 plan period.

In operation, soon after the debtor files for bankruptcy protection under Chapter 13, a bankruptcy court typically requires each of the debtor's creditors to file a “proof of claim” with the bankruptcy court by a certain date (called the “bar date”) in order to establish that creditor's claim to any pre-petition debt incurred by the debtor. As used herein, the phrase “pre-petition debt” refers to the debt that was incurred by the debtor prior to the time the debtor filed for bankruptcy. It will be understood that, in most cases, the bankruptcy court appoints a trustee to collect money from the debtor and make payments to each of the creditors that hold pre-petition debt incurred by the debtor.

In addition to incurring pre-petition debt, the debtor may also incur additional debt after filing for Chapter 13 protection, especially where the debtor has an ongoing relationship with the creditor, such as, for example, where the creditor is a home mortgage loan lender and the debtor is a home mortgage loan borrower. The debt incurred after a bankruptcy petition has been filed is commonly known as “post-petition debt,” and the law generally requires that payments be made on this type of debt alongside the payments being made on the debtor's pre-petition debt. However, unlike pre-petition debt that may be repaid over the duration of the Chapter 13 plan period, post-petition debt generally must be repaid as if the debtor never filed for bankruptcy in the first place. For example, where a debtor has missed ten $600 monthly mortgage payments before filing for Chapter 13 protection and where the Chapter 13 plan period is 60 months in duration, the borrower (or, in some cases, the trustee) may be responsible for making a $700 payment to the lender each and every month during the course of the Chapter 13 plan period (i.e., $600 pre-petition mortgage payment*10 missed months=$6,000 in pre-petition debt; $6,000 pre-petition debt/60 months for Chapter 13 plan period=$100 monthly pre-petition debt payment; $100 pre-petition debt payment+$600 post-petition mortgage payment (post-petition debt payment)=$700 total monthly debt payment due during the Chapter 13 plan period). It will be understood that, in many instances, the debtor is responsible for making payments on his or her own post-petition debt, but there are some instances where the trustee will collect and make payments on the debtor's post-petition debt as well as on the debtor's pre-petition debt (e.g., where the bankruptcy case associated with the debtor is a “payall” or “trustee payall” bankruptcy case).

Of course, in some situations, the debtor is unable to make the required debt payments on both the post-petition debt and the pre-petition debt. When this happens, especially when there is collateral involved (e.g., property that secures a home mortgage loan, etc.), the creditor may file a Motion for Relief from Stay that asks the bankruptcy court to lift the debtor's bankruptcy protection in order to allow the creditor to repossess, sell, and/or otherwise take the collateral used to secure the debt. Many times, however, the bankruptcy court will deny this motion in order to give the debtor another chance to preserve the collateral. However, this typically means that the debtor, in addition to the original Chapter 13 payment plan, must agree to a post-petition payment plan that requires the debtor to cure the post-petition arrearage over a relatively short period of time (e.g., six months, etc.). It will be understood that the debt outlined in this post-petition payment plan is commonly referred to as “stipulated agreement debt” because the debtor and the creditor often stipulate to the terms of the post-petition payment plan.

Accordingly, it will be understood that a bankruptcy creditor, particularly where that bankruptcy creditor is a large financial institution, may hold pre-petition debt, post-petition debt, and/or stipulated agreement debt incurred by one or more bankruptcy debtors. Over time, it can be very difficult for the creditor to accurately track each of the debtor's debts, the one or more payments applied to those debts, as well as other information associated with the debtors and/or the corresponding bankruptcy cases. Accordingly, there is a need to provide methods and apparatuses for tracking payments and debts associated with bankruptcy debtors, so that a bankruptcy creditor can readily determine payment information and debt information associated with one or more bankruptcy debtors.

### SUMMARY OF SELECTED EMBODIMENTS OF THE PRESENT INVENTION

In general terms, embodiments of the present invention relate to methods and apparatuses for tracking payments and debts associated with a bankruptcy debtor. For example, where a debtor files for bankruptcy protection under Chapter 13 of the United States Bankruptcy Code, some embodiments of the present invention enable a corresponding creditor to receive, process, and/or track various types of information associated with the debtor, including, for example, payment information, debt information (e.g,. pre-petition debt, post-petition debt, stipulated agreement debt, etc.), remaining balance information, paid through date (PTD) information, bankruptcy case information, debtor information, account information, and/or the like. In some embodiments, this information is posted to a network-accessible account associated with the debtor, where the network-accessible account is accessible to the creditor, to the debtor, to a trustee associated with the bankruptcy case, and/or to some other entity.

Additionally or alternatively, some embodiments of the present invention are configured to receive one or more payments associated with the debtor, to determine that those one or more payments apply to at least one of pre-petition debt, post-petition debt, and/or stipulated agreement debt associated with the debtor, and/or to actually apply those one or more payments to the debtor's pre-petition debt, post-petition debt, and/or stipulated agreement debt. Also, some embodiments of the present invention are additionally or alternatively configured to determine that a bankruptcy case associated with the debtor has been initiated, to determine whether a proof of claim is required in the debtor's bankruptcy case, to generate the proof of claim, and/or to transmit the proof of claim to a bankruptcy attorney for filing with a bankruptcy court. Also, some embodiments of the present invention are additionally or alternatively configured to determine whether one or more received payments triggers one or more exceptions, and some embodiments are configured to generate and post information associated with those one or more exceptions to the network-accessible account associated with the debtor. Further, some embodiments are configured to enable a user of an apparatus to access the network-accessible account in order to view the exception information, the payment information, and/or the debt information, all in order to direct the apparatus and/or some other apparatus to take one or more actions (e.g., apply the one or more payments in a particular way, clear the one or more exceptions, etc.).

More specifically, in some embodiments of the present invention, a method is provided that includes: (a) receiving information associated with one or more payments, where the one or more payments are associated with a debtor; (b) determining, using a processor, that a first portion of the one or more payments applies to pre-petition debt associated with the debtor; (c) determining, using a processor, that a second portion of the one or more payments applies to post-petition debt associated with the debtor; and (d) posting, to a network-accessible account associated with the debtor, information that indicates that the first portion applies to the pre-petition debt and information that indicates that the second portion applies to the post-petition debt.

In some embodiments, the method includes: (a) applying, using a processor, the first portion to the pre-petition debt; and (b) applying, using a processor, the second portion to the post-petition debt. In some embodiments of the method, determining that the first portion applies to the pre-petition debt includes determining, using a processor, that the first portion applies to the pre-petition debt based at least partially on a determination that the first portion was received from a trustee. Also, in some embodiments of the method, determining that the second portion applies to the post-petition debt includes determining, using a processor, that the second portion applies to the post-petition debt based at least partially on a determination that the second portion was received from the debtor.

In some embodiments, the method includes: (a) determining, using a processor, that a third portion of the one or more payments applies to stipulated agreement debt associated with the debtor; and (b) posting, to the network-accessible account, information that indicates that the third portion applies to the stipulated agreement debt. In other embodiments, the method additionally includes applying, using a processor, the third portion to the stipulated agreement debt.

In some embodiments, the method includes posting, to the network-accessible account, information associated with a proof of claim associated with the debtor. In other embodiments, the method additionally or alternatively includes: (a) generating, using a processor, a proof of claim for a bankruptcy case associated with the debtor; and (b) transmitting, using a communication interface, the proof of claim to an attorney for filing with a court.

Additionally, in some embodiments, the method includes: (a) determining, using a processor, that at least one payment from the one or more payments triggers a fund allocation exception; and (b) posting, to the network-accessible account, information associated with the fund allocation exception. Some embodiments of the method include: (a) receiving, from the network-accessible account, one or more user inputs regarding the fund allocation exception; and (b) applying, using a processor and based at least partially on the one or more user inputs, the at least one payment to at least one of the pre-petition debt or the post-petition debt.

Similarly, in some embodiments, the method includes: (a) determining, using a processor, that at least one payment from the one or more payments triggers a payment exception; and (b) posting, to the network-accessible account, information associated with the payment exception. In addition, some embodiments of the method include: (a) receiving, from the network-accessible account, one or more user inputs regarding the payment exception; and (b) applying, using a processor and based at least partially on the one or more user inputs, the at least one payment to at least one of the pre-petition debt or the post-petition debt.

In some embodiments of the method, determining that the first portion applies to the pre-petition debt includes determining, using a processor, that the first portion applies to the pre-petition debt based at least partially on one or more user inputs. Additionally or alternatively, in other embodiments of the method, determining that the second portion applies to the post-petition debt includes determining, using a processor, that the second portion applies to the post-petition debt based at least partially on one or more business rules.

In some embodiments, the method includes: (a) determining, using a processor, a pre-petition debt paid through date (PTD) as a result of applying the first portion to the pre-petition debt; (b) determining, using a processor, a post-petition debt PTD as a result of applying the second portion to the post-petition debt; and (c) posting, to the network-accessible account, information associated with the pre-petition debt PTD and information associated with the post-petition debt PTD. Also, in some embodiments, the method includes: (a) determining, using a processor, a remaining balance of the pre-petition debt as result of applying the first portion to the pre-petition debt; and (b) posting, to the network-accessible account, information associated with the remaining balance of the pre-petition debt.

As another example, in some embodiments of the present invention, a system is provided that includes: (a) a tracking apparatus including: (i) a communication interface configured to receive information associated with one or more payments, wherein the one or more payments are associated with a bankruptcy debtor; and (ii) a processor operatively connected to the communication device and configured to: (A) determine that a first portion of the one or more payments applies to pre-petition debt associated with the debtor; and (B) determine that a second portion of the one or more payments applies to post-petition debt associated with the debtor; and (b) a user interface apparatus operatively connected to the tracking apparatus and including a user interface configured to display information that indicates that the first portion applies to the pre-petition debt and information that indicates that the second portion applies to the post-petition debt.

In some embodiments of the system, the processor is configured to post, to a network-accessible account associated with the debtor, information that indicates that the first portion applies to the pre-petition debt and information that indicates that the second portion applies to the post-petition debt. Additionally or alternatively, in some embodiments, the user interface apparatus is configured to access the network-accessible account to display, at the user interface, the information that indicates that the first portion applies to the pre-petition debt and the information that indicates that the second portion applies to the post-petition debt.

In some embodiments of the system, the processor is configured to: (a) apply the first portion to the pre-petition debt; and (b) apply the second portion to the post-petition debt. In some embodiments, the processor is configured to determine that the first portion applies to the pre-petition debt based at least partially on a determination that the first portion was received from a trustee. In other embodiments, the processor is additionally or alternatively configured to determine that the second portion applies to the post-petition debt based at least partially on a determination that the second portion was received from the debtor.

In some embodiments of the system, the processor is configured to determine that a third portion of the one or more payments applies to stipulated agreement debt associated with the debtor, and the user interface apparatus is configured to display, at the user interface, information that indicates that the third portion applies to the stipulated agreement debt. In some embodiments, the processor is configured to apply the third portion to the stipulated agreement debt.

In some embodiments of the system, the user interface apparatus is configured to display, at the user interface, information associated with a proof of claim associated with the debtor. In some embodiments, the processor is configured to generate a proof of claim for a bankruptcy case associated with the debtor, and the communication interface is configured to transmit the proof of claim to an attorney for filing with a court. In some embodiments, the processor is configured to determine that at least one payment from the one or more payments triggers a fund allocation exception, and the user interface apparatus is configured to display, at the user interface, information associated with the fund allocation exception.

In some embodiments, the communication interface is configured to receive, from the user interface apparatus, one or more user inputs regarding the fund allocation exception, and the processor is configured to apply, based at least partially on the one or more user inputs, the at least one payment to at least one of the pre-petition debt or the post-petition debt. In some embodiments, the processor is configured to determine that at least one payment from the one or more payments triggers a payment exception, and the user interface apparatus is configured to display, at the user interface, information associated with a network-accessible account associated with the debtor. In some embodiments, the information associated with the network-accessible account includes information associated with the payment exception.

In some embodiments of the system, the communication interface is configured to receive, from the user interface apparatus, one or more user inputs regarding the payment exception, and the processor is configured to apply the at least one payment to at least one of the pre-petition debt or the post-petition debt. In some embodiments, the processor is configured to determine: (a) a pre-petition debt PTD as a result of applying the first portion to the pre-petition debt; and (b) a post-petition debt PTD as a result of applying the second portion to the post-petition debt. In some embodiments, the user interface apparatus is configured to display, at the user interface, information associated with the pre-petition debt PTD and information associated with the post-petition debt PTD. Also, in some embodiments, the processor is configured to determine a remaining balance of the pre-petition debt as result of applying the first portion to the pre-petition debt, and the user interface apparatus is configured to display, at the user interface, information associated with the remaining balance of the pre-petition debt.

As another example, in some embodiments of the present invention, a computer program product having a non-transitory computer-readable medium is provided. The computer-readable medium includes computer-executable program code portions stored therein, and the computer-executable program code portions include: (a) a first program code portion configured to determine that a first portion of one or more payments applies to pre-petition debt associated with a debtor; (b) a second program code portion configured to determine that a second portion of the one or more payments applies to post-petition debt associated with the debtor; and (c) a third program code portion configured to post, to a network-accessible account associated with the debtor, information that indicates that the first portion applies to the pre-petition debt and information that indicates that the second portion applies to the post-petition debt.

### BRIEF DESCRIPTION OF THE DRAWINGS

Having thus described embodiments of the present invention in general terms, reference will now be made to the accompanying drawings, wherein:

FIG. 1 is a flow diagram illustrating a general process flow of an apparatus for tracking payments and debts associated with a bankruptcy debtor, in accordance with an embodiment of the present invention;

FIG. 2 is a flow diagram illustrating a general process flow of an apparatus for tracking payments and debts associated with a bankruptcy debtor, in accordance with an embodiment of the present invention;

FIG. 2A is a flow diagram illustrating a general process flow of an apparatus for tracking payments and debts associated with a bankruptcy debtor, in accordance with an embodiment of the present invention;

FIG. 2B is a flow diagram illustrating a general process flow of an apparatus for tracking payments and debts associated with a bankruptcy debtor, in accordance with an embodiment of the present invention;

FIG. 3 is a block diagram illustrating technical components of a system for tracking payments and debts associated with a bankruptcy debtor, in accordance with an embodiment of the present invention;

FIG. 4 is a mixed block and flow diagram of a system for tracking payments and debts associated with a bankruptcy debtor, in accordance with an embodiment of the present invention;

FIG. 5 illustrates an exemplary browser page that displays information from a network-accessible account associated with a bankruptcy debtor, in accordance with an embodiment of the present invention;

FIG. 6 illustrates an exemplary browser page that displays information from a network-accessible account associated with a bankruptcy debtor, in accordance with an embodiment of the present invention; and

FIG. 7 illustrates an exemplary browser page that displays information from a network-accessible account associated with a bankruptcy debtor, in accordance with an embodiment of the present invention.

### DETAILED DESCRIPTION OF EMBODIMENTS OF THE PRESENT INVENTION

Embodiments of the present invention will now be described more fully hereinafter with reference to the accompanying drawings, in which some, but not all, embodiments of the present invention are shown. Indeed, the present invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and/or vice versa, unless explicitly stated otherwise. Also, as used herein, the term “a” and/or “an” shall mean “one or more,” even though the phrase “one or more” is also used herein. Like numbers refer to like elements throughout.

As will be appreciated by one of ordinary skill in the art in view of this disclosure, the present invention may be embodied as an apparatus (including, for example, a system, machine, device, computer program product, and/or the like), as a method (including, for example, a business process, computer-implemented process, and/or the like), or as any combination of the foregoing. Accordingly, embodiments of the present invention may take the form of an entirely software embodiment (including firmware, resident software, micro-code, etc.), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

It will also be understood that one or more computer-executable program code portions for carrying out operations of the present invention may include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

It will also be understood that the one or more computer-executable program code portions may be stored in a transitory and/or non-transitory computer-readable medium (e.g., memory, etc.) that can direct a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator- and/or human-implemented steps in order to carry out an embodiment of the present invention.

Further, although many of the embodiments of the present invention described herein are generally described as involving a “financial institution,” other embodiments of the present invention may involve one or more persons, organizations, businesses, and/or other entities that take the place of, and/or work in conjunction with, the financial institution to implement one or more portions of the one or more embodiments described and/or contemplated herein.

It will also be understood that the terms “debtor” and “bankruptcy debtor,” as used herein, typically refer to an entity (e.g., individual, partnership, corporation, etc.) that has incurred one or more debts and is subject to a pending or past bankruptcy case. The term “creditor,” as used herein, typically refers to an entity (e.g., individual, partnership, corporation, etc.) to whom the debtor owes the one or more debts. For simplicity, most of the embodiments described herein involve a financial institution as the creditor and an individual person as the debtor who has filed a petition for bankruptcy under Chapter 13. However, it will be understood that, where possible, the embodiments of the present invention can apply to any other type of debtor (e.g., corporation, partnership, etc.), to any other type of creditor (e.g., individual, partnership, etc.), and/or to any other type of bankruptcy case (e.g., those filed under Chapter 11, Chapter 12, etc.) and/or other related law, rule, and/or regulation.

In general terms, embodiments of the present invention relate to methods and apparatuses for tracking payments and debts associated with a bankruptcy debtor. For example, where a debtor files for bankruptcy protection under Chapter 13 of the United States Bankruptcy Code, some embodiments of the present invention enable a corresponding creditor to receive, process, and/or track various types of information associated with the debtor, including, for example, payment information, debt information (e.g,. pre-petition debt, post-petition debt, stipulated agreement debt, etc.), remaining balance information, paid through date (PTD) information, bankruptcy case information, debtor information, account information, and/or the like. In some embodiments, this information is posted to a network-accessible account associated with the debtor, where the network-accessible account is accessible to the creditor, to the debtor, to a trustee associated with the bankruptcy case, and/or to some other entity.

Additionally or alternatively, some embodiments of the present invention are configured to receive one or more payments associated with the debtor, to determine that those one or more payments apply to at least one of pre-petition debt, post-petition debt, and/or stipulated agreement debt associated with the debtor, and/or to actually apply those one or more payments to the debtor's pre-petition debt, post-petition debt, and/or stipulated agreement debt. Also, some embodiments of the present invention are additionally or alternatively configured to determine that a bankruptcy case associated with the debtor has been initiated, to determine whether a proof of claim is required in the debtor's bankruptcy case, to generate the proof of claim, and/or to transmit the proof of claim to a bankruptcy attorney for filing with a bankruptcy court. Also, some embodiments of the present invention are additionally or alternatively configured to determine whether one or more received payments triggers one or more exceptions, and some embodiments are configured to generate and post information associated with those one or more exceptions to the network-accessible account associated with the debtor. Further, some embodiments are configured to enable a user of an apparatus to access the network-accessible account in order to view the exception information, the payment information, and/or the debt information, all in order to direct the apparatus and/or some other apparatus to take one or more actions (e.g., apply the one or more payments in a particular way, clear the one or more exceptions, etc.).

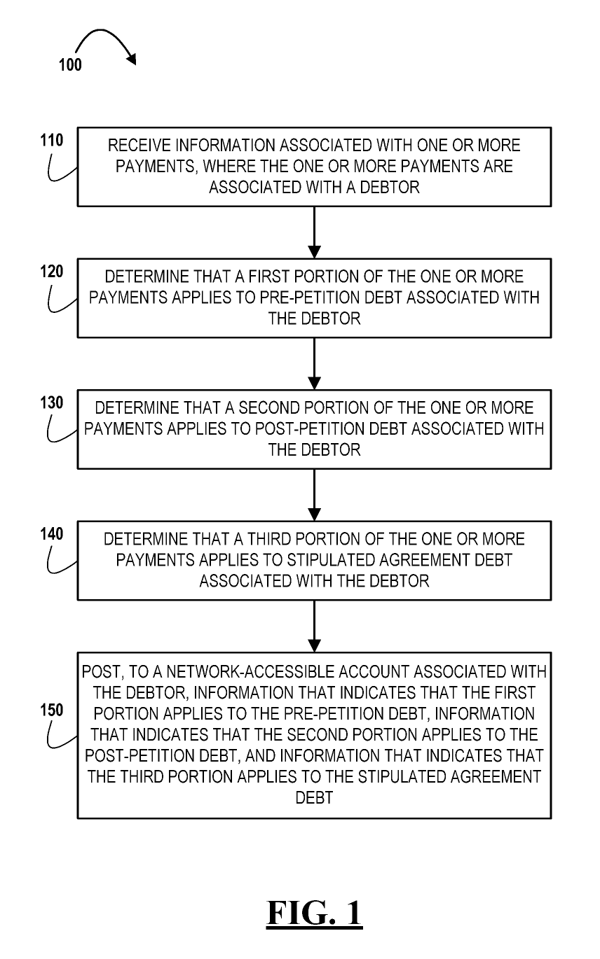

Referring now to FIG. 1, a general process flow 100 of an apparatus for tracking payments and debts associated with a bankruptcy debtor is provided, in accordance with an embodiment of the present invention. As represented by the block 110, the apparatus is configured to receive information associated with one or more payments, where the one or more payments are associated with the debtor. As represented by the block 120, the apparatus is also configured to determine that a first portion of the one or more payments applies to pre-petition debt associated with the debtor. As represented by the block 130, the apparatus is further configured to determine that a second portion of the one or more payments applies to post-petition debt associated with the debtor. As represented by the block 140, the apparatus is also configured to determine that a third portion of the one or more payment applies to stipulated agreement debt associated with the debtor. In addition, as represented by the block 150, the apparatus is further configured to post, to a network-accessible account associated with the debtor, information that indicates that the first portion applies to the pre-petition debt, information that indicates that the second portion applies to the post-petition debt, and information that indicates that the third portion applies to the stipulated agreement debt.

For simplicity, it will be understood that the portions of the process flow represented by the blocks 120-140 are sometimes referred to herein as “debt determinations.” Also for simplicity, it will also be understood that the information referred to in the block 110 is sometimes referred to as “received payment information,” and the information referred to in the block 150 is sometimes referred to as “payment application information.” In addition, it will be understood that, the term “determine,” as used herein, is meant to have its ordinary meaning (i.e., its ordinary dictionary definition) in addition to the one or more ordinary meanings of the following terms: decide, conclude, verify, ascertain, discover, learn, calculate, observe, read, and/or the like.

Regarding the block 110, it will be understood that the received payment information can include any type and/or amount of information. In some embodiments, the received payment information includes the one or more payments themselves and/or other information about the one or more payments, such that the apparatus having the process flow 100 is able to apply and/or otherwise process the one or more payments itself. In such embodiments, the received payment information may include, for example, one or more financial instruments (e.g., electronic and/or physical checks, money orders, cash, etc.), routing numbers, account numbers, payment amounts, identities of the loan(s) and/or debt(s) to which the one or more payments apply, the identity of the relevant bankruptcy case and/or the one or more entities interested in the bankruptcy case (e.g., creditor, debtor, trustee, court official, etc.), and/or the like.

In other embodiments, however, the apparatus having the process flow 100 is configured to track information associated with the one or more payments but is not configured to apply and/or otherwise process the one or more payments. Instead, in such embodiments, the apparatus having the process flow 100 is configured to receive only the information necessary to enable the apparatus to make the debt determinations and post the payment application information. Of course, it will be understood that, in accordance with some embodiments of the present invention, the apparatus having the process flow 100 can be configured to track payment information and debt information, as well as apply and/or otherwise process the one or more payments received.

It will also be understood that the information associated with the one or more payments can be received in any way. For example, in some embodiments, the apparatus having the process flow 100 is configured to receive the information in electronic form, such as, for example, by receiving electronic data via a network (e.g., the Internet, the Automated Clearing House (ACH) network, a financial institution intranet, etc.). As another example, in some embodiments, the apparatus is configured to receive the information in physical form (e.g., from one or more physical checks, payment forms, etc.). In such embodiments, the apparatus can be configured to create an electronic representation of the physical source of the information and/or coordinate with one or more other apparatuses to do the same. For example, in some embodiments, the apparatus includes and/or coordinates with a scanner to scan a received physical check in order to create an electronic representation of that check for further processing.

In addition, it will be understood that the received payment information can be received from any entity. It will be understood that the term “entity” can include the entity itself, one or more employees and/or agents of the entity, and/or one or more apparatuses associated with the entity and/or controlled, serviced, owned, operated, managed, stored, and/or maintained (collectively referred to herein as “maintained” for simplicity) by the entity. For example, in some embodiments, the apparatus having the process flow 100 is configured to receive the received payment information from one or more apparatuses maintained by a financial institution (e.g., a financial institution separate from the entity that maintains the apparatus having the process flow 100, etc.).

As another example, in some embodiments, the apparatus having the process flow 100 is configured to receive the received payment information from an entity interested in the bankruptcy case, such as, for example, a creditor, debtor, trustee, court official, and/or the like. It will be understood that, in some embodiments, the apparatus having the process flow 100 is configured to receive the received payment information directly from the entity interested in the bankruptcy case (e.g., an employee of a creditor uses a user interface operatively connected to the apparatus having the process flow 100 to, e.g., scan/upload a physical check, enter payment information, etc. directly into the apparatus having the process flow 100, etc.). In other embodiments, the apparatus having the process flow 100 is additionally or alternatively configured to receive the received payment information indirectly from an entity interested in the bankruptcy case (e.g., a trustee uses a user interface apparatus maintained by the trustee to transmit the payment information, via a network, to the apparatus having the process flow 100, etc.).

Further, it will be understood that the apparatus having the process flow 100 can be configured to receive and process the received payment information in any order. For example, in some embodiments, the apparatus is configured to receive information associated with a first payment, determine how that first payment applies to one or more of the debtor's debts, and post the payment application information associated with the first payment, all before the apparatus receives and/or processes information associated with a second payment. As another example, in some embodiments, the apparatus is configured to receive and process the information associated with three separate payments at the same time or nearly the same time.

Regarding the blocks 120-140, it will be understood that one or more portions of the one or more payments may apply entirely to the pre-petition debt, entirely to the post-petition debt, entirely to the stipulated agreement debt, or to some combination of the pre-petition debt, the post-petition debt, and/or the stipulated agreement debt. For example, in some embodiments, where information associated with two payments is received, the apparatus having the process flow 100 is configured to determine that the first payment applies entirely to the pre-petition debt and that the second payment applies entirely to the post-petition debt (and that no portion of the two payments applies to the stipulated agreement debt). As another example, in some embodiments, where information associated with a single payment is received, the apparatus having the process flow 100 is configured to determine that a first portion of that single payment applies to the pre-petition debt, that a second portion of that single payment applies to the post-petition debt, and that a third portion of that single payment applies to the stipulated agreement debt.

As still another example, in some embodiments, where information associated with five payments are received, the apparatus having the process flow 100 is configured to determine that a first portion of those five payments (e.g., payments one through three and a first portion of payment four, etc.) applies to the pre-petition debt, and that a second portion of those five payments applies to the post-petition debt (e.g., payment five and a second portion of payment four, etc.). Of course, it will be understood that some payments may not apply to pre-petition debt (or to post-petition debt or to stipulated agreement debt), and that, in such cases, the apparatus having the process flow 100 can be configured to omit the portions of the process flow 100 associated with the pre-petition debt (or the post-petition debt or the stipulated agreement debt).

It will also be understood that the apparatus having the process flow 100 can be configured to make the debt determinations in any way. For example, in some embodiments, the apparatus is configured to make one or more of the debt determinations based at least partially on one or more business rules (e.g., one or more business rules embodied in one or more computer-executable program code portions provided to the apparatus having the process flow 100, etc.). In some embodiments, the one or more business rules relate to the source of the one or more payments. It will be understood that the source of the one or more payments can be important where the bankruptcy case is considered a “non-payall” case. Typically, in a “non-payall” case, a trustee associated with the bankruptcy case is responsible for collecting money from the debtor and making payments to each of the debtor's creditors for all of the pre-petition debt incurred by the debtor. Also in a “non-payall” case, the debtor is typically responsible for making payments to his or her creditors for all of the post-petition debt and/or stipulated agreement debt incurred by the debtor. Thus, in some embodiments, where the bankruptcy case is a “non-payall” case, the apparatus having the process flow 100 can be configured to make one or more of the debt determinations based at least partially on whether a payment was received from the trustee or from the debtor.

Specifically, in some embodiments, the apparatus having the process flow 100 is configured to determine that the first portion of the one or more payments applies to pre-petition debt associated with the debtor based at least partially on a determination that the first portion was received from a trustee (e.g., a trustee associated with the bankruptcy case, etc.). Additionally or alternatively, in some embodiments, the apparatus having the process flow 100 is configured to determine that the second portion of the one or more payments applies to post-petition debt based at least partially on a determination that the second portion was received from a debtor (e.g., the debtor associated with the bankruptcy case, etc.). Also, in some embodiments, the apparatus having the process flow 100 is additionally or alternatively configured to determine that the third portion of the one or more payments applies to stipulated agreement debt based at least partially on a determination that the third portion was received from a debtor (e.g., the debtor associated with the bankruptcy case, etc.).

Sometimes, however, the source of the one or more payments does not help the apparatus having the process flow 100 determine whether the one or more payments apply to pre-petition debt, post-petition debt, and/or stipulated agreement debt. For example, the source of a payment is typically not determinative in a “payall” bankruptcy case because, in such a case, the trustee is typically responsible for collecting money from the debtor and making payments to the each of the debtor's creditors for all of the pre-petition debt, post-petition debt, and/or stipulated agreement debt incurred by the debtor. Thus, in some embodiments where the bankruptcy case is a payall case, the apparatus having the process flow 100 is configured to make one or more of the debt determinations based at least partially on something other than the source(s) of the one or more payments. (Of course, it will be understood that, in some embodiments, the apparatus having the process flow 100 is configured to make one or more of the debt determinations based at least partially on something other than the source(s) of the one or more payments, even where the bankruptcy case is a non-payall case.)

As an example, in some embodiments, the apparatus having the process flow 100 is configured to make one or more of the debt determinations based at least partially on one or more laws, rules, and/or regulations. In some embodiments, this includes one or more laws, rules, and/or regulations from the jurisdiction(s) in which the bankruptcy court sits and/or the bankruptcy case arose. In some instances, these one or more laws, rules, and/or regulations affect the particular order in which the one or more payments can be applied. For example, in some embodiments, the apparatus having the process flow 100 is configured to determine, in accordance with a local bankruptcy law, that the one or more payments apply to a minimum payment due (e.g., a monthly payment amount, etc.) on the debtor's pre-petition debt first, then to a minimum payment due on the debtor's post-petition debt second, and then to a minimum payment due on the debtor's stipulated agreement debt third. As a specific example, in accordance with some embodiments, if a single $900 payment is received by the apparatus having the process flow 100, if the minimum payment due on the debtor's pre-petition debt is $75, if the minimum payment due on the debtor's post-petition debt is $800, and if the minimum payment due on the debtor's stipulated agreement debt is $100, then the apparatus having the process flow 100 is configured to determine that $75 of the $900 payment applies to the pre-petition debt, that $800 of the $900 payment applies to the post-petition debt, and that the remaining $25 of the $900 payment applies to the stipulated agreement debt. Of course, it will be understood that the apparatus having the process flow 100 can be configured to make one or more of the debt determinations based at least partially on one or more other laws, rules, and/or regulations.

As another example, in some embodiments, the apparatus having the process flow 100 is additionally or alternatively configured to make one or more of the debt determinations based at least partially on one or more user inputs. For example, in some embodiments, after the apparatus having the process flow 100 receives the received payment information, the apparatus is configured to enable a user of a user interface apparatus operatively connected to the apparatus having the process flow 100 in order to direct the apparatus having the process flow 100 regarding how the one or more payments should be applied. In some embodiments, the user uses a user interface apparatus to access the network-accessible account and view information associated with the one or more payments, information associated with the debtor's pre-petition debt, post-petition debt, and/or stipulated agreement debt, and/or other information provided by the network-accessible account, all in order to direct the apparatus having the process flow 100, via one or more user inputs, how the one or more payments should be applied. In some embodiments, the user provides the one or more user inputs to the apparatus having the process flow 100 in response to one or more payment exceptions and/or fund allocation exceptions, which are described in more detail later herein.

Regarding the block 150, it will be understood that the apparatus having the process flow 100 can be configured to post the payment application information to a network-accessible account based at least partially on one or more business rules, based at least partially on one or more laws, rules, and/or regulations, and/or based at least partially on one or more user inputs. It will also be understood that the network-accessible account can be embodied as a debtor and/or user profile, a debtor and/or user account, a virtual account, a dashboard profile, an online banking account, and/or some other type of network-accessible account. In some embodiments, the network-accessible account is associated with and/or maintained by the creditor, which, in some embodiments, is a bank and/or a financial institution. It will also be understood that the network-accessible account typically includes information associated with one or more debts (e.g., pre-petition debt, post-petition debt, stipulated agreement debt, which may include credit card debt, mortgage loan debt, HELOC debt, student loan debt, etc.), information associated with one or more payments (e.g., payment amounts, payment dates, payment application information, etc.), and/or information associated with one or more bankruptcy cases (e.g., bankruptcy filing date, bankruptcy plan information, identity of the trustee, type of bankruptcy, etc.). In some embodiments, the network-accessible account is secure and/or private, such that it requires a username and password and/or one or more other credentials in order to access the account.

It will also be understood that the payment application information posted to the network-accessible account can include any amount and/or type of information. For example, in some embodiments, the information includes one or more payment amounts, payment dates, information about the one or more debt to which the one or more payments apply (and/or were applied), and/or the like. Also, the apparatus having the process flow 100 can be configured to post the payment application information to the network-accessible account in substantially real time as one or more of the debt determinations are made and/or as the one or more payments are applied. The apparatus having the process flow 100 can additionally or alternatively be configured to post the payment application information sometime after one or more of the debt determinations are made and/or after the one or more payments are applied.

It will be understood that, in some embodiments, the pre-petition debt, the post-petition debt, the stipulated agreement debt, and/or the apparatus having the process flow 100 are maintained by a single financial institution. For example, in accordance with some embodiments, the debtor is a home mortgage loan borrower who had missed several mortgage payments prior to filing for Chapter 13 protection (pre-petition debt), the debtor also owes regular, ongoing mortgage payments after filing for Chapter 13 protection (post-petition debt), and the apparatus having the process flow 100 is maintained by a creditor who is the home mortgage loan lender to whom the borrower owes the missed and ongoing mortgage payments. Of course, in other embodiments, the apparatus having the process flow 100 is not maintained by one or more of the debtor's creditors (or by any creditor).

It will also be understood that the apparatus having the process flow 100 can be configured to perform one or more portions of the process flow 100 in real time, in substantially real time, and/or at one or more predetermined times. For example, in some embodiments, as mentioned above, the apparatus is embodied as a payment processing apparatus that is configured to apply and/or otherwise process one or more debt payments involving the debtor's pre-petition debt, post-petition debt, and/or stipulated agreement debt. In some of these embodiments, the apparatus having the process flow 100 is configured to make one or more of the debt determinations at the same time as, or nearly the same time as, the apparatus is applying and/or otherwise processing the debt payments associated with the debtor. As another example, in some embodiments, the apparatus is configured to post the payment application information represented by the block 150 continuously, such that the apparatus can post how the one or more payments were applied immediately or nearly immediately after the one or more payments were actually applied. As another example, in some embodiments, the apparatus is configured to make one or more of the debt determinations at a specific time during the day, such as, for example, at the end of day, at mid day, at the beginning of day, at 12:45 pm, etc. In other embodiments, the apparatus is configured to make these determinations at the end of every week, at the end of the month, when one or more payments post to the network-accessible account, and/or at one or more other predetermined times.

It will further be understood that the apparatus having the process flow 100 can be configured to perform any of the portions of the process flow 100 represented by the blocks 110-150 upon or after one or more triggering events (which, in some embodiments, is one or more of the other portions of the process flow 100). As used herein, it will be understood that a “triggering event” refers to an event that automatically triggers the execution, performance, and/or implementation of a triggered action, either immediately, nearly immediately, or sometime after (e.g., within the same day or week or month, at a predetermined time, etc.) the occurrence of the triggering event. For example, in some embodiments, the apparatus having the process flow 100 is configured such that the apparatus receiving the information associated with the one or more payments (the triggering event) automatically triggers the apparatus to make one or more of the debt determinations (the triggered action). In some embodiments, the apparatus is additionally or alternatively configured to automatically post the payment application information to the network-accessible account (triggered action) immediately or nearly immediately after making one or more of the debt determinations (triggering event). However, in other embodiments, instead of immediately or nearly immediately after making one or more of the debt determinations, the apparatus is configured to automatically post the payment application information to the network-accessible account at some predetermined time after making one or more of the debt determinations (e.g., forty-eight hours after making them, at the end of day on the Friday after making them, etc.). It will be understood that, in some embodiments, a predetermined time and/or the passage of a predetermined period of time may serve to trigger one or more of the portions represented by the blocks 110-150. It will also be understood that, in accordance with some embodiments, the apparatus having the process flow 100 is configured to automatically perform one or more of the portions of the process flow 100 represented by the blocks 110-150.

Further, it will be understood that the number, order, and/or content of the portions represented by the blocks 110-150 are exemplary and may vary. For example, in some embodiments, the apparatus having the process flow 100 is configured to omit the portions of the process flow 100 associated with stipulated agreement debt because, for example, the debtor has not incurred any stipulated agreement debt. As another example, in some embodiments, the apparatus having the process flow 100 is configured to determine that the second portion of the one or more payments applies to the post-petition debt associated with the debtor before determining that the first portion of the one or more payments applies to the pre-petition debt associated with the debtor.

As still another example, in some embodiments, the apparatus having the process flow 100 can be configured to perform one or more additional or alternative functions. For example, in some embodiments, the apparatus having the process flow 100 is additionally or alternatively configured to: (a) determine a pre-petition debt paid through date (PTD) as a result of applying the first portion to the pre-petition debt; (b) determine a post-petition debt PTD as a result of applying the second portion to the post-petition debt; and/or (c) determine a stipulated agreement debt PTD as a result of applying the third portion to the stipulated agreement debt. It will be understood that the phrase “as a result of applying” is not meant to indicate that the apparatus having this alternative process flow 100 actually applies and/or otherwise processes the one or more payments (even though it can be configured to do so, as discussed above). Instead, the phrase “as a result of applying” is merely used to indicate that the apparatus can be configured to determine what the PTD(s) would be if one or more apparatuses (which may include the apparatus having the process flow 100) applied the one or more payments. Also, it will be understood that, in some embodiments, the apparatus having this alternative process flow 100 is configured to post, to the network-accessible account associated with the debtor, information associated with the pre-petition debt PTD, information associated with the post-petition debt PTD, and/or information associated with the stipulated agreement debt PTD.

It will also be understood that a debt PTD typically refers to the date through which the amount due on the corresponding debt has been paid. For example, if the post-petition debt associated with the debtor is a monthly mortgage payment, if the monthly mortgage payment is due on or before the first of every month, and if the debtor has made every required monthly mortgage payment up to and including the one due on Jan. 1, 2010, then the post-petition debt PTD in this example is Jan. 1, 2010. Using the same example, if the debtor submits another monthly mortgage payment on or before Feb. 1, 2010, but does not submit monthly mortgage payments for either March or April, then the post-petition debt PTD on Apr. 15, 2010, would be Feb. 1, 2010. On the other hand, still using the same example, if the debtor had submitted the monthly mortgage payments for both March and April, then the post-petition debt PTD on Apr. 15, 2010, would be Apr. 1, 2010.

It will further be understood that, in some embodiments, the apparatus having this alternative process flow 100 is configured to determine and/or post the pre-petition debt PTD relative to the post-petition debt PTD. For example, in some embodiments, if the post-petition debt associated with the debtor is a monthly mortgage payment, if the monthly mortgage payment is due on or before the first of every month, if the pre-petition debt associated with the debtor is four missed mortgage payments, and if the post-petition debt PTD associated with the debtor is Apr. 1, 2010, then the apparatus is configured, in some embodiments, to determine that the pre-petition debt PTD associated with the debtor is Dec. 1, 2010. It will be understood that this does not necessarily mean that the debtor has paid the amount due on the pre-petition debt through Dec. 1, 2010; instead, in some embodiments, this pre-petition debt PTD, when read in conjunction with the post-petition debt PTD, merely indicates that the four missed mortgage payments have not yet been repaid. Thus, using the same example in the beginning of this paragraph, if the debtor submits a monthly mortgage payment on or before May 1, 2010, then the post-petition debt PTD would be May 1, 2010, and the pre-petition debt PTD would be Jan. 1, 2010 (i.e., the date exactly four months before May 1, 2010), which indicates that the debtor is current on his post-petition mortgage payments through May 1, 2010, but still has not yet repaid the four missed mortgage payments incurred prior to filing for bankruptcy. It will be understood that, by providing the debtor's pre-petition debt PTD relative to the debtor's post-petition debt PTD in this way, the apparatus having this alternative process flow 100 enables a user to readily determine the payment information and debt information associated with the debtor.

It will also be understood that instead of, or in addition to, the PTD, the apparatus having the process flow 100 can be configured to determine the days past due (DPD) associated with the pre-petition debt, post-petition debt, and/or stipulated agreement debt. For example, in some embodiments, where the debtor's post-petition mortgage payment is a week late, the apparatus having this alternative process flow 100 is configured to determine that the post-petition debt DPD associated with the debtor is 7 days. As another example, in some embodiments, where the debtor has missed four monthly mortgage payments prior to filing for Chapter 13 protection, the apparatus having this alternative process flow 100 is configured to determine that the pre-petition debt DPD associated with the debtor at the time of the bankruptcy filing is 122 days.

As another example of an additional or alternative function, in some embodiments, the apparatus having the process flow 100 is additionally or alternatively configured to: (a) determine a remaining balance of the pre-petition debt as a result of applying the first portion to the pre-petition debt; (b) determine a remaining balance of the post-petition debt as a result of applying the second portion to the post-petition debt; and/or (c) determine a remaining balance of the stipulated agreement debt as a result of applying the third portion to the stipulated agreement debt. Again, it will be understood that the phrase “as a result of applying” is not meant to indicate that the apparatus having this alternative process flow 100 actually applies and/or otherwise processes the one or more payments (even though it can be configured to do so, as discussed above). Instead, the phrase “as a result of applying” is merely used to indicate that the apparatus can be configured to determine what the remaining balance(s) would be if one or more apparatuses (which may include the apparatus having the process flow 100) applied the one or more payments. In addition, it will be understood that, in some embodiments, the apparatus having this alternative process flow 100 is additionally configured to post, to the network-accessible account associated with the debtor, information associated with the remaining balance of the pre-petition debt, information associated with the remaining balance of the post-petition debt, and/or information associated with the remaining balance of the stipulated agreement debt.

Further, it will be understood that, in some embodiments, the apparatus having the process flow 100 (and/or any of the other process flows described and/or contemplated herein) is also configured to implement, communicate with, and/or be otherwise associated with online and/or mobile banking services. For example, in some embodiments, the apparatus having the process flow 100 is also configured to deliver online and/or mobile banking services to one or more online banking customers via one or more online and/or mobile banking accounts. As another example, in some embodiments, one or more portions of an online and/or mobile banking account (e.g., an online banking tool, etc.) are configured to configure and/or trigger the apparatus having the process flow 100 to perform one or more of the portions of the process flow 100. In some embodiments, the online and/or mobile banking account may additionally or alternatively be configured to receive one or more notifications associated with one or more of the portions of the process flow 100 (e.g., a digital receipt created/sent by the apparatus that includes information associated with a payment, etc.).

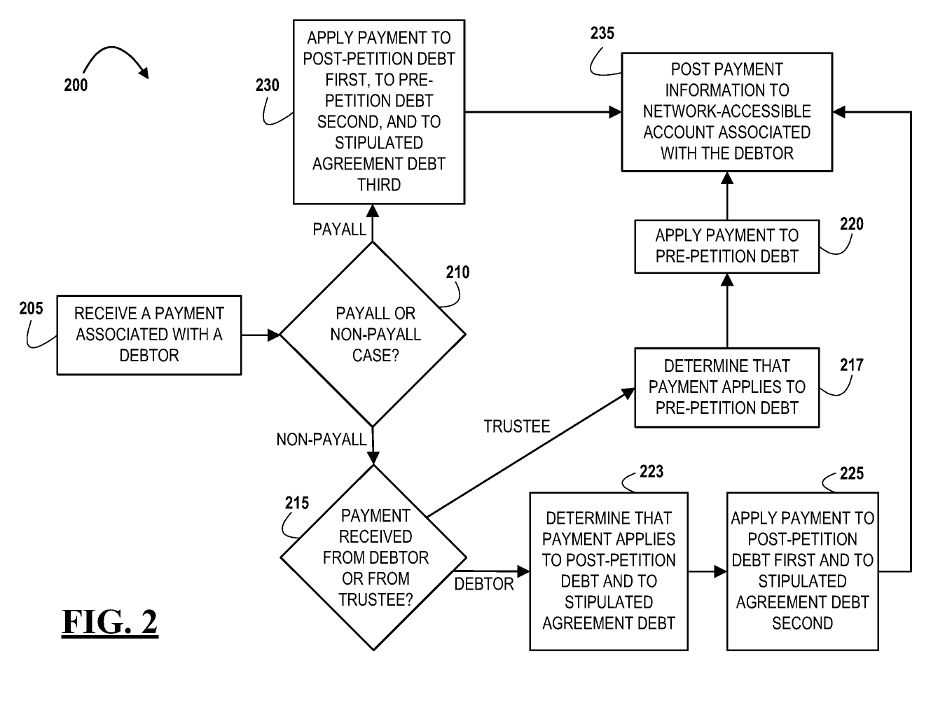

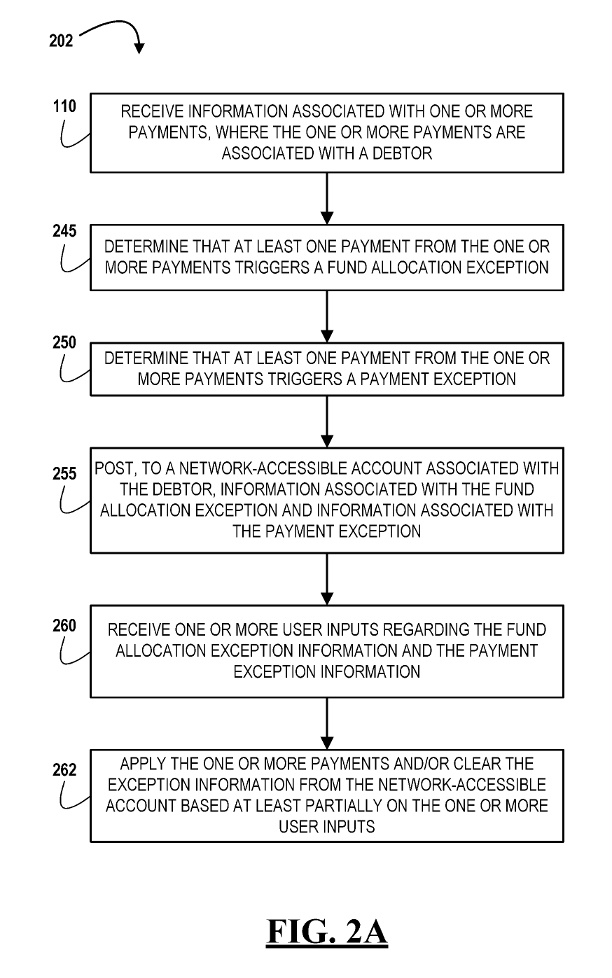

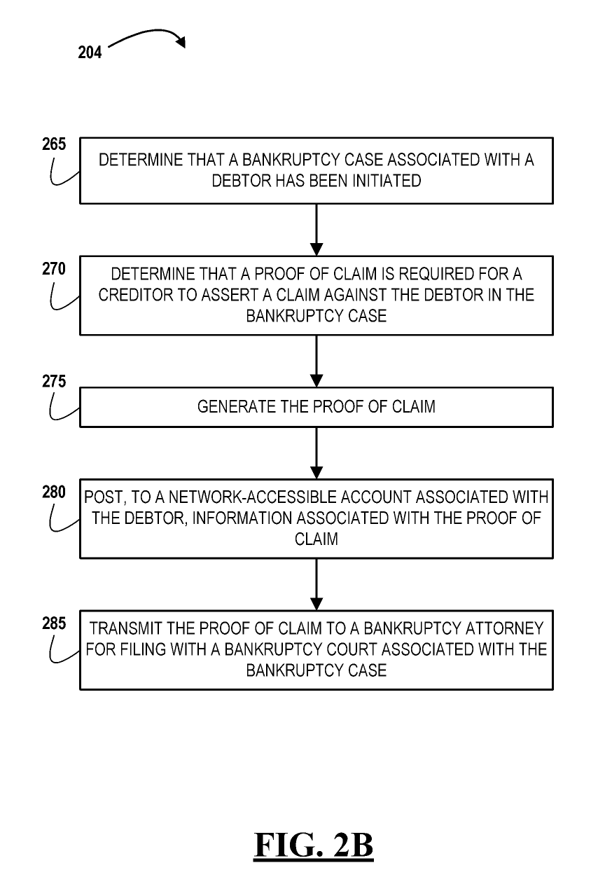

Referring now to FIG. 2, a more-detailed process flow 200 of an apparatus for tracking payments and debts associated with a bankruptcy debtor is provided, in accordance with an embodiment of the present invention. It will be understood that an apparatus having the process flow 200 can be configured to perform one or more portions of the process flow 100 shown in FIG. 1, and/or vice versa. It will also be understood that, in addition to being configured to track payments and debts associated with the debtor, the apparatus having the process flow 200 is also configured to apply and/or otherwise process one or more payments associated with the debtor. It will be further understood that, for purposes of illustration and not limitation, the debtor referred to in the process flow 200 is subject to a bankruptcy case under Chapter 13 and that the debtor has incurred pre-petition debt, post-petition debt, and stipulated agreement debt. Also for purposes of illustration and not limitation, the apparatus having the process flow 200 is maintained by the creditor that holds the pre-petition debt, post-petition debt, and stipulated agreement debt incurred by the debtor.

As represented by the block 205, the apparatus having the process flow 200 is configured to receive a payment associated with the debtor. Then, as represented by the block 210, the apparatus is configured to determine whether the debtor is subject to a payall bankruptcy case or a non-payall bankruptcy case. If the apparatus determines that the debtor is subject to a non-payall case, then the apparatus is configured to determine whether the payment was received from the debtor or from a trustee (e.g., a trustee associated with the debtor's bankruptcy case, etc.), as represented by the block 215. If the apparatus determines that the payment was received from a trustee, then the apparatus is configured to determine that the payment applies to pre-petition debt associated with the debtor, as represented by the block 217. After making this debt determination, the apparatus is further configured to apply and/or otherwise process the payment to the debtor's pre-petition debt, as represented by the block 220. Thereafter, as represented by the block 235, the apparatus having the process flow 200 is configured to post information associated with the payment (e.g., payment amount, payment date, how the payment was applied, etc.) to a network-accessible account associated with the debtor.

However, if the apparatus having the process flow 200 determines that the payment is received from the debtor, then the apparatus is configured to determine that the payment applies to the post-petition debt and the stipulated agreement debt associated with the debtor, as represented by the block 223. Thereafter, the apparatus is configured to apply and/or otherwise process the payment based at least partially on one or more business rules that direct the apparatus to apply the payment to the post-petition debt first and then to the stipulated agreement debt second, as represented by the block 225. For example, in accordance with some embodiments, if a $250 payment is received from the debtor, if the minimum payment due on the post-petition debt is $220, and if the minimum payment due on the stipulated agreement debt is $50, then the apparatus having the process flow 200 is configured to apply $220 of the $250 payment to the post-petition debt and the remaining $30 of the $250 payment to the stipulated agreement debt, which means the debtor still owes $20 on the minimum payment due for the stipulated agreement debt. As an alternative example, if the payment amount is $200 instead of $250, then the apparatus having the process flow 200 is configured to apply the entire $200 of the $200 payment to the post-petition debt and nothing to the stipulated agreement debt, which means the debtor still owes $20 for the minimum payment due on the post-petition debt and $50 for the minimum payment due on the stipulated agreement debt. As represented by the block 235, after the apparatus has applied the payment to the post-petition debt and the stipulated agreement debt (or just the post-petition debt), the apparatus is configured to post information associated with the payment to the network-accessible account associated with the debtor.

Referring again to the block 210, if the apparatus having the process flow 200 determines that the bankruptcy case is a payall case, then the apparatus is configured to apply and/or otherwise process the payment based at least partially on one or more business rules that direct the apparatus to apply the payment to the post-petition debt first, to the pre-petition debt second, and to the stipulated agreement debt third, as represented by the block 230. For example, in accordance with some embodiments, if a $480 payment is received from the trustee in a payall case, if the minimum payment due on the post-petition debt is $400, if the minimum payment due on the pre-petition debt is $50, and if the minimum payment due on the stipulated agreement debt is $30, then the apparatus having the process flow 200 is configured to apply $400 of the $480 payment to the post-petition debt first, $50 of the $480 to the pre-petition debt second, and the remaining $30 of the $480 payment to the stipulated agreement debt third. Using the same example, if the payment amount is $300 instead of $480, then the apparatus having the process flow 200 is configured to apply the entire $300 of the $300 payment to the post-petition debt, nothing to the pre-petition debt, and nothing to the stipulated agreement debt, which means the debtor still owes $100 for the minimum payment due on the post-petition debt, $50 for the minimum payment due on the pre-petition debt, and $30 for the minimum payment due on the stipulated agreement debt. After the apparatus has applied the payment, as represented by the block 235, the apparatus having the process flow 200 is configured to post information associated with the payment to the network-accessible account associated with the debtor.

In some embodiments, instead of applying the payment to at least one of the debtor's debts, the apparatus having the process flow 200 is configured to apply the payment (or part of the payment) to a “partial” account that corresponds to at least one of the debtor's pre-petition debt, post-petition debt, or stipulated agreement debt. In some embodiments, this partial account is used to hold money from one or more payments (or portions of payments) until enough money has accumulated in the partial account to pay off a predetermined amount of the debtor's debt. For example, in some embodiments, where the debtor is a home mortgage loan borrower, where the borrower's post-petition mortgage payment is $800, and where the debtor submits only a $125 post-petition mortgage payment, the apparatus having the process flow 200 is configured to apply the $125 payment to the post-petition debt partial account associated with the debtor. In such embodiments, if the debtor later submits one or more post-petition mortgage payments equal to or greater than $675, then the apparatus having the process flow 200 will sweep the $125 from the post-petition debt partial account and combine it with the $675 from the one or more additional payments in order to apply an $800 post-petition mortgage payment to the debtor's home mortgage loan.

As another example, in some embodiments, where the debtor's pre-petition debt includes ten missed $400 mortgage payments, and where the apparatus having the process flow 200 determines that a $300 received payment applies to pre-petition debt, the apparatus is configured to apply the entire amount of the $300 payment to a pre-petition debt partial account until that partial account has enough money to cover one of the ten missed $400 mortgage payments. Thus, in such embodiments, if the apparatus having the process flow 200 receives another payment for $150, then the apparatus would combine the $150 payment with the $250 in the pre-petition debt partial account in order to apply the resulting $400 to the pre-petition debt associated with the debtor (e.g., apply the $400 to cure one of the pre-petition mortgage payments missed prior to the bankruptcy filing, etc.). Afterwards, there would still be $50 remaining in the pre-petition debt partial account for combining with one or more payments received in the future.

As mentioned previously, it will be understood that the embodiment illustrated in FIG. 2 is merely exemplary and other embodiments may vary without departing from the scope and spirit of the present invention. For example, other embodiments of the present invention may rely on one or more different business rules, one or more laws, rules, and/or regulations, and/or one or more user inputs to determine the particular order in which the payment is applied. As another example, in some embodiments, the apparatus having the process flow 200 is configured to determine how the payment applies but is not actually configured to apply the payment itself. In addition, it will also be understood that the apparatus having the process flow 200 can be configured to perform one or more portions of the process flow 200 in real time, in substantially real time, and/or at one or more predetermined times. It will further be understood that the apparatus having the process flow 200 can be configured to perform any of the portions of the process flow 200 represented by the blocks 205-235 upon or after one or more triggering events (which, in some embodiments, is one or more of the other portions of the process flow 200).

Referring now to FIG. 2A, a general process flow 202 of an apparatus for tracking payments and debts associated with a bankruptcy debtor is provided, in accordance with an embodiment of the present invention. It will be understood that an apparatus having the process flow 202 can be configured to perform one or more portions of the process flow 100 shown in FIG. 1, one or more portions of process flow 200 shown in FIG. 2, and/or vice versa. It will also be understood that, in addition to being configured to track payments and debts associated with the debtor, the apparatus having the process flow 202 is also configured to: (a) apply and/or otherwise process one or more payments associated with the debtor; and (b) determine, post, and clear exceptions (e.g., issues, problems, errors, etc.) that are associated with those one or more payments and/or with applying those one or more payments to the one or debts associated with the debtor. It will be further understood that, for purposes of illustration and not limitation, the debtor referred to in the process flow 202 is subject to a bankruptcy case under Chapter 13 and that the debtor has incurred pre-petition debt, post-petition debt, and stipulated agreement debt. It will also be understood that, in this embodiment, the apparatus having the process flow 202 is maintained by the creditor that holds the debtor's pre-petition debt, post-petition debt, and stipulated agreement debt.

As represented by the block 110 shown in FIG. 2A, the apparatus having the process flow 202 (like the apparatus having the process flow 100) is configured to receive information associated with one or more payments, where the one or more payments are associated with the debtor. As represented by the block 245, the apparatus is also configured to determine that at least one payment from the one or more payments triggers a fund allocation exception. In addition, as represented by the block 250, the apparatus is further configured to determine that at least one payment from the one or more payments triggers a payment exception. Thereafter, as represented by the block 255, the apparatus having the process flow 202 is configured to post, to a network-accessible account associated with the debtor, information associated with the fund allocation exception and information associated with the payment exception. As represented by the block 260, the apparatus is further configured to receive one or more user inputs regarding the fund allocation exception and the payment exception. Thereafter, as represented by the block 262, the apparatus is configured to apply the one or more payments and/or clear the exceptions based at least partially on the one or more user inputs.

Regarding the block 245, it will also be understood that the apparatus having the process flow 202 is configured to determine that a payment triggers a fund allocation exception where the apparatus is unable to determine, or otherwise experiences difficulty in determining, how to apply the payment to the debtor's pre-petition debt, post-petition debt, and/or stipulated agreement debt. For example, in some embodiments, the apparatus having the process flow 202 is configured to determine that a payment triggers a fund allocation exception based at least partially on a determination (e.g., a user determination, a determination made by the apparatus having the process flow 202, a determination made by another apparatus, etc.) that the payment is associated with a debtor who is subject to a payall bankruptcy case. Such embodiments may exist, for example, where the creditor prefers that a user (e.g., an employee and/or agent of the apparatus, etc.), instead of the apparatus having the process flow 202, makes the debt determinations for payments associated with payall bankruptcy cases. Accordingly, in such embodiments, the apparatus is configured to post information associated with the fund allocation exception to the network-accessible account, so that the user may view the exception information and other information associated with the debtor (e.g., payment information, debt information, bankruptcy case information, etc.) in order to provide, via the account, the apparatus having the process flow 202 with one or more user inputs that direct the apparatus how to apply the payment.

Regarding the block 250, it will be understood that the apparatus having the process flow 202 is configured to determine that a payment triggers a payment exception where the apparatus determines that one or more errors are associated with the payment information. For example, in some embodiments, the apparatus having the process flow 202 is configured to determine that a payment triggers a payment exception based at least partially on a determination (e.g., a user determination, a determination made by the apparatus having the process flow 202, a determination made by another apparatus, etc.) that the payment information is missing critical information, such as, for example, the payment amount, the identity of the debtor and/or bankruptcy case, the account number and/or routing number of the drawer account, etc. Other examples of how payment exceptions may arise include, but are not limited to, where the trustee inadvertently sends in a payment to the wrong creditor, where the debtor has sent a payment that is required by law to come from the trustee, where the debt to which the payment applies cannot be identified (e.g., where the payor requests that the payment be applied to a loan that does not exist, etc.), and/or the like. In accordance with some embodiments, where the apparatus having the process flow 202 determines that the payment information triggers a payment exception, the apparatus is configured to post information associated with the payment exception to the network-accessible account, so that the user may view the exception information and other information associated with the debtor (e.g., payment information, debt information, bankruptcy case information, etc.) in order to provide, via the account, the apparatus having the process flow 202 with one or more user inputs that direct the apparatus what to do with the payment (e.g., apply the payment to the debtor's debt if the user can determine how the payment should be applied, notify the payor of the error(s) if the user cannot, etc.).

Regarding the blocks 245 and 250, it will also be understood that, by the phrase “at least one payment,” it is meant that one or more of the one or more payments triggers one or more fund allocation exceptions and/or one or more payment exceptions. For example, where the apparatus having the process flow 202 receives information associated with four payments, the apparatus may be configured to determine that the first payment triggers one fund allocation exception, the second payment triggers no exceptions, the third payment triggers two payment exceptions, and the fourth payment triggers one fund allocation exception and two payment exceptions. As another example, where the apparatus receives information associated with two payments, the apparatus may be configured to determine that the first and second payments each trigger one fund allocation exception but neither triggers a payment exception. It will be understood that, in some embodiments, the at least one payment referred to in the blocks 245 and 250 is the same payment from the one or more payments.

Regarding the block 255, it will be understood that the fund allocation exception information and the payment exception information that is posted to the network-accessible account can include any amount and/or type of information. For example, in some embodiments, this information identifies the type of exception, describes the exception, explains why the exception was triggered, and/or the like. In some embodiments, the fund allocation exception information and/or the payment exception information are provided in the network-accessible account as one or more notifications, selectable links, web pages, tabs, line items, and/or the like.

Regarding the blocks 260-262, it will be understood that, in some embodiments, the apparatus having the process flow 202 is configured to receive the one or more user inputs from a user interface apparatus operatively connected, via a network, to the apparatus having the process flow 202. In other embodiments, the apparatus having the process flow 202 is configured to receive the one or more user inputs from a user interface of the apparatus having the process flow 202. In still other embodiments, the apparatus having the process flow 202 is configured to receive the one or more user inputs regarding the exceptions from a network-accessible account associated with the debtor. For example, in accordance with some embodiments, where a payment has triggered a fund allocation exception, and where information associated with a fund allocation exception is posted to the network-accessible account associated with the debtor, a user (e.g., employee of the creditor, etc.) may: (a) access the network-accessible account; (b) view the fund allocation exception information, the payment information, the debt information, and the bankruptcy case information; and (c) direct the apparatus having the process flow 202, via one or more user inputs communicated through the network-accessible account, to apply the payment in a particular way.

It will be understood that, in some embodiments, the apparatus having the process flow 202 is configured to clear the fund allocation exception information and/or the payment exception information from the network-accessible account upon or after the apparatus having the process flow 202 receives the one or more user inputs. In other embodiments, the apparatus is configured to clear the exceptions upon or after the apparatus applies and/or otherwise processes the one or more payments that triggered the one or more exceptions.

Also, it will be understood that the embodiment illustrated in FIG. 2A is merely exemplary and other embodiments may vary without departing from the scope and spirit of the present invention. In addition, it will also be understood that the apparatus having the process flow 202 can be configured to perform one or more portions of the process flow 202 in real time, in substantially real time, and/or at one or more predetermined times. It will further be understood that the apparatus having the process flow 202 can be configured to perform any of the portions of the process flow 202 represented by the blocks 110-262 upon or after one or more triggering events (which, in some embodiments, is one or more of the other portions of the process flow 202).

Referring now to FIG. 2B, a general process flow 204 of an apparatus for tracking payments and debts associated with a bankruptcy debtor is provided, in accordance with an embodiment of the present invention. It will be understood that the apparatus having the process flow 204 can be configured to perform one or more portions of the process flow 100 shown in FIG. 1, one or more portions of process flow 200 shown in FIG. 2, one or more portions of the process flow 202 shown in FIG. 2A, and/or vice versa. It will also be understood that, in addition to being configured to track payments and debts associated with the debtor, the apparatus having the process flow 204 is also configured to generate, post, and transmit a proof of claim associated with the debtor's bankruptcy case. It will further be understood that the apparatus having the process flow 204 can be configured to perform the portions of the process flow 204 represented by the blocks 265-285 shortly after the bankruptcy case associated with the debtor has been initiated. In such embodiments, the apparatus may perform one or more of the portions of the process flow 204 before the debtor incurs any post-petition debt and/or any stipulated agreement debt. For purposes of illustration and not limitation, it will be understood that, in this embodiment, the apparatus having the process flow 204 is maintained by a creditor who holds only pre-petition debt incurred by the debtor.

As represented by the block 265, the apparatus having the process flow 204 is configured to determine that a bankruptcy case associated with the debtor has been initiated. As represented by the block 270, the apparatus is also configured to determine that a proof of claim (POC) is required for the creditor to assert a claim against the debtor in the bankruptcy case. As represented by the block 275, the apparatus is further configured to generate the proof of claim, and, as represented by the block 280, the apparatus is configured to post, to a network-accessible account associated with the debtor, information associated with the proof of claim. Then, as represented by the block 285, the apparatus is configured to transmit the proof of claim to a bankruptcy attorney for filing with a bankruptcy court associated with the bankruptcy case.

Regarding the blocks 265-270, the apparatus having the process flow 204 can be configured to determine that a bankruptcy case has been initiated and/or that a proof of claim is required in any way. For example, in some embodiments, the apparatus is configured to make these determinations based at least partially on one or more user inputs provided to the apparatus having the process flow 204. As another example, in some embodiments, the apparatus having the process flow 204 is configured to make these determinations based at least partially on information received from one or more other apparatuses. In some embodiments, the apparatus is configured to make these determinations based at least partially on one or more business rules and/or based at least partially on one or more laws, rules, and/or regulations. For example, in some embodiments, the apparatus having the process flow 204 is configured to determine that a proof of claim is required based at least partially on a bankruptcy law that governs the jurisdiction in which the bankruptcy case was initiated.

Regarding the block 275, the apparatus having the process flow 204 can be configured to generate the proof of claim in any way. For example, in some embodiments, the apparatus is configured to generate a physical proof of claim document that may be mailed and/or otherwise physically delivered to the bankruptcy attorney for filing. In such embodiments, the form and content of the proof of claim document may conform to one or more laws, rules, and/or regulations associated with the bankruptcy case and/or the bankruptcy court. As another example, in some embodiments, the apparatus having the process flow 204 is configured to generate an electronic representation of the physical proof of claim document, so that the document may be electronically delivered to the attorney and/or electronically filed with the bankruptcy court.

Regarding the block 280, it will be understood that the information associated with the proof of claim can include any amount and/or type of information. For example, in some embodiments, the proof of claim information includes one or more claim amounts, one or more payment amounts, and one or more claim balances. As another example, in some embodiments, the information associated with the proof of claim includes an electronic representation of the actual proof of claim document filed with the bankruptcy court. As mentioned previously herein, it will be understood that the information associated with the proof of claim typically includes only information associated with pre-petition debt incurred by the debtor.

Regarding the block 285, it will be understood that the apparatus having the process flow 204 can be configured to transmit the proof of claim to the bankruptcy attorney in any way. For example, in some embodiments, the apparatus is configured to electronically transmit the proof of claim to the bankruptcy attorney, such as, for example, by delivering an electronic representation of the proof of claim to the bankruptcy attorney's email account, mobile device, and/or the like. As another example, in some embodiments, the apparatus is configured to prepare the proof of claim for physical delivery (e.g., regular mail, personal delivery, etc.), such as, for example, by printing the proof of claim, packaging the proof of claim, and/or the like. In addition, in some embodiments, it will be understood that, instead of transmitting the proof of claim directly to the bankruptcy attorney, the apparatus is configured to transmit the proof of claim to an employee and/or agent of the bankruptcy attorney, and/or to one or more apparatuses maintained by the bankruptcy attorney. Also, it will be understood that, in some embodiments, the apparatus generating the proof of claim automatically triggers the apparatus to transmit the proof of claim to the bankruptcy attorney.

In some alternative embodiments of the process flow 204, the apparatus is additionally configured to: (a) determine that the proof of claim triggers a proof of claim exception; (b) post, to a network-accessible account associated with the debtor, information associated with the proof of claim exception; (c) receive one or more user inputs regarding the proof of claim exception; and (d) clear, based at least partially on the one or more user inputs, the proof of claim exception information from the network-accessible account. Similar to the fund allocation exception and the payment exception described in connection with FIG. 2A, the apparatus having this alternative process flow 204 is configured to determine that a proof of claim triggers a proof of claim exception where the apparatus determines that one or more errors are associated with the proof of claim. For example, in some embodiments, a proof of claim exception is triggered where the apparatus is unable to determine, or otherwise experiences difficulty in determining, that a proof of claim is required in the bankruptcy case. As another example, in some embodiment, a proof of claim exception is triggered where the apparatus is unable to generate the proof of claim because, for example, the apparatus is missing critical information associated with the proof of claim (e.g., the identity and/or amount of the pre-petition debt, information associated with the bankruptcy court and/or bankruptcy case, etc.).

As a further example, in some embodiments, the apparatus is configured to determine that a proof of claim triggers a proof of claim exception where the creditor and/or some other user of the apparatus has placed a flag and/or hold on information associated with the debtor (e.g., on the network-accessible account associated with the debtor, on the pre-petition debt associated with the debtor, on the bankruptcy case associated with the debtor, etc.). For example, in some embodiments, the creditor may want to check with a litigation attorney before the proof of claim is generated, transmitted, and/or filed with the bankruptcy court. In such embodiments, the apparatus is configured to post information associated with the proof of claim exception to the network-accessible account, so that a user may, for example, view the exception information and other information associated with the debtor (e.g., payment information, debt information, bankruptcy case information, etc.) in order to provide, via the account, the apparatus having this alternative process flow 204 with one or more user inputs that direct the apparatus how to proceed.

Also, it will be understood that the embodiment illustrated in FIG. 2B is merely exemplary and other embodiments may vary without departing from the scope and spirit of the present invention. In addition, it will also be understood that the apparatus having the process flow 204 can be configured to perform one or more portions of the process flow 204 in real time, in substantially real time, and/or at one or more predetermined times. It will further be understood that the apparatus having the process flow 204 can be configured to perform any of the portions of the process flow 204 represented by the blocks 265-285 upon or after one or more triggering events (which, in some embodiments, is one or more of the other portions of the process flow 204).

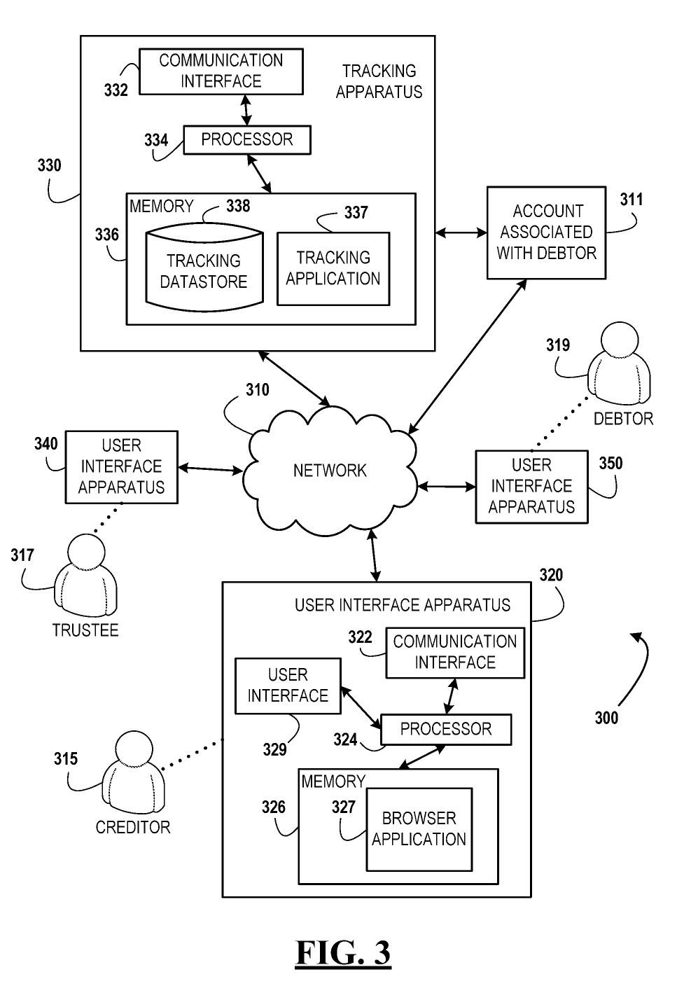

Referring now to FIG. 3, a system 300 for tracking payments and debts associated with a bankruptcy debtor is provided, in accordance with an embodiment of the present invention. As illustrated, the system 300 includes a network 310, a user interface apparatus 320, a tracking apparatus 330, a user interface apparatus 340, and a user interface apparatus 350. FIG. 3 also illustrates a creditor 315 as a user of the user interface apparatus 320, a trustee 317 as a user of the user interface apparatus 340, and a debtor 319 as a user of the user interface apparatus 350. It will be understood that the creditor 315 has access to the user interface apparatus 320, the trustee 317 has access to the user interface apparatus 340, and the debtor 319 has access to the user interface apparatus 350. It will also be understood that, in this embodiment, the user interface apparatus 320 and the tracking apparatus 330 are maintained by the creditor 317. FIG. 3 also illustrates a network-accessible account 311 that is associated with the debtor 319, is stored in the tracking datastore 338 of the tracking apparatus 330, and is thus maintained by the creditor 315. However, it will also be understood that the network-accessible account 311 is also operatively connected to, via the network 310, the user interface apparatus 320 and the other portions of the system 300.

As shown in FIG. 3, the user interface apparatus 320, the tracking apparatus 330, the user interface apparatus 340, the user interface apparatus 350, and the network-accessible account 311 are each operatively and selectively connected to the network 310, which may include one or more separate networks. In addition, the network 310 may include a local area network (LAN), a wide area network (WAN), and/or a global area network (GAN), such as the Internet. It will also be understood that the network 310 may be secure and/or unsecure and may also include wireless and/or wireline technology.

Each of the user interface apparatuses described herein, including the user interface apparatus 320, may include any computerized apparatus that can be configured to perform any one or more of the functions of the user interface apparatus 320 described and/or contemplated herein. In some embodiments, for example, the user interface apparatus may include a personal computer system, a mobile phone, a personal digital assistant, a public kiosk, a network device, and/or the like. As illustrated in FIG. 3, the user interface apparatus 320 includes a communication interface 322, a processor 324, a memory 326 having a browser application 327 stored therein, and a user interface 329. The communication interface 322 is operatively and selectively connected to the processor 324, which is operatively and selectively connected to the user interface 329 and the memory 326. It will be understood that, in accordance with some embodiments, the user interface apparatus 340 and the user interface apparatus 350 include components that are similar and/or identical to the components included in the user interface apparatus 320.

Each communication interface described herein, including the communication interface 322, generally includes hardware, and, in some instances, software, that enables a portion of the system 300, such as the user interface apparatus 320, to transmit, send, receive, and/or otherwise communicate information to and/or from the communication interface of one or more other portions of the system 300. For example, the communication interface 322 of the user interface apparatus 320 may include a modem, server, electrical connection, and/or other electronic device that operatively connects the user interface apparatus 320 to another electronic device, such as the electronic devices that make up the tracking apparatus 330.

Each processor described herein, including the processor 324, generally includes circuitry for implementing the audio, visual, and/or logic functions of that portion of the system 300. For example, the processor may include a digital signal processor device, a microprocessor device, and various analog-to-digital converters, digital-to-analog converters, and other support circuits. Control and signal processing functions of the system in which the processor resides may be allocated between these devices according to their respective capabilities. The processor may also include functionality to operate one or more software programs based at least partially on computer-executable program code portions thereof, which may be stored, for example, in a memory device, such as in the browser application 327 of the memory 326 of the user interface apparatus 320.

Each memory device described herein, including the memory 326 for storing the browser application 327 and other data, may include any computer-readable medium. For example, memory may include volatile memory, such as volatile random access memory (RAM) having a cache area for the temporary storage of data. Memory may also include non-volatile memory, which may be embedded and/or may be removable. The non-volatile memory may additionally or alternatively include an EEPROM, flash memory, and/or the like. The memory may store any one or more of pieces of information and data used by the system in which it resides to implement the functions of that system.

As shown in FIG. 3, the memory 326 includes the browser application 327. In some embodiments, the browser application 327 includes a web browser, navigation program, and/or some other application for accessing, navigating, controlling, configuring, using, and/or communicating with one or more network-accessible accounts, the tracking apparatus 330, and/or one or more other portions of the system 300. In some embodiments, the browser application 327 is configured to perform, or facilitate performing, one or more portions of the one or more embodiments described and/or contemplated herein. For example, in some embodiments, the creditor 315 uses the browser application 327 to access a network-accessible account associated with the debtor 319 in order to view the information posted, stored, and/or otherwise included therein (e.g., payment information, debt information, bankruptcy case information, exception information, proof of claim information, etc.). As another example, in some embodiments, the creditor 315 uses the browser application 327 to provide one or more user inputs to the tracking apparatus 330. In some embodiments, these one or more user inputs direct the tracking apparatus 330 to apply one or more payments to the debtor's debt, to clear one or more exceptions, and/or to take some other action regarding one or more payments and/or debts associated with the debtor 319. As still another example, in some embodiments, the creditor 315 uses the browser application 327 to view, navigate, and/or communicate with the browser pages 500-700 described below. In some embodiments, the browser application 327 includes computer-executable program code portions for instructing the processor 324 to perform one or more of the functions of the browser application 327 described and/or contemplated herein. In some embodiments, the browser application 327 may include and/or use one or more network and/or system communication protocols.

Also shown in FIG. 3 is the user interface 329. In some embodiments, the user interface 329 includes one or more user output devices, such as a display and/or speaker, for presenting information to the creditor 315. In some embodiments, the user interface 329 includes one or more user input devices, such as one or more buttons, keys, dials, levers, directional pads, joysticks, accelerometers, controllers, microphones, touchpads, touchscreens, haptic interfaces, microphones, scanners, motion detectors, cameras, and/or the like for receiving information from the creditor 315. In some embodiments, the user interface 329 includes the input and display devices of a personal computer, such as a keyboard and monitor, that are operable to receive one or more inputs and display one or more outputs that, for example, are associated with tracking debts and payments associated with the debtor 319. As a more-specific example, in some embodiments, the user interface 329 is configured to display the browser pages 500-700 described below.

FIG. 3 also illustrates a tracking apparatus 330, in accordance with an embodiment of the present invention. The tracking apparatus 330 may include any computerized apparatus that can be configured to perform any one or more of the functions of the tracking apparatus 330 described and/or contemplated herein. In accordance with some embodiments, for example, the tracking apparatus 330 may include an engine, a platform, a server, a database system, a front end system, a back end system, a personal computer system, and/or the like. In some embodiments, such as the one illustrated in FIG. 3, the tracking apparatus 330 includes a communication interface 332, a processor 334, and a memory 336, which includes a tracking application 337 and a tracking datastore 338 stored therein. As shown, the communication interface 332 is operatively and selectively connected to the processor 334, which is operatively and selectively connected to the memory 336.

It will be understood that the tracking application 337 can be configured to perform any one or more portions of any one or more of the embodiments described and/or contemplated herein. For example, in some embodiments, the tracking application 337 is configured to determine that a first portion of one or more payments received applies to pre-petition debt associated with a debtor. As another example, in some embodiments, the tracking application 337 is configured to determine a pre-petition debt PTD and/or a remaining balance of the pre-petition debt as a result of applying a portion of one or more received payments to the pre-petition debt. As still another example, in some embodiments, the tracking application 337 is configured to post, to a network-accessible account, information associated with one or more payments, debts, exceptions, PTDs, remaining balances, and/or other related information. As a further example, in some embodiments, the tracking application 337 is configured to determine whether a bankruptcy petition has been filed and/or whether a proof of claim associated with that bankruptcy petition is required. As still another example, in some embodiments, the tracking application 337 is configured to generate a proof of claim associated with a bankruptcy case, store information associated with the proof of claim in the tracking datastore 338, and/or transmit the proof of claim to a bankruptcy attorney for filing.

It will also be understood that, in some embodiments, the tracking application 337 is additionally configured to provide other kinds of financial services. For example, in some embodiments, the tracking application 337 is configured to apply and/or otherwise process one or more received payments associated with a debtor. In some cases, this function is performed alongside one or more of the portions described and/or contemplated herein that relate to receiving information associated with one or more payments, making debt determinations, and/or posting information associated with the one or more payments and/or debts. For example, where the debtor 319 uses the user interface apparatus 350 to submit, to the tracking apparatus 330, a payment that applies to the debtor's post-petition debt, the tracking application 337 can be configured to: (a) receive the information associated with the payment; (b) determine that the payment applies to the post-petition debt associated with the debtor; (c) apply the payment to the post-petition debt; (d) determine the post-petition debt PTD and/or the remaining balance of the post-petition debt as a result of applying the payment; and (e) post, to a network-accessible account associated with a debtor, information associated with the payment, the post-petition PTD, the remaining balance of the post-petition debt, and/or other related information. As another example, in some embodiments, the tracking application 337 is additionally or alternatively configured to provide online and/or mobile banking services to the debtor 319 at the user interface apparatus 350, to the creditor 315 at the user interface apparatus 320 (e.g., in some embodiments where the tracking apparatus 320 is not maintained by the creditor 315, etc.), and/or to the trustee 317 at the user interface apparatus 340.

It will also be understood that, in some embodiments, the tracking application 337 is configured to communicate with the account datastore 338, the user interface apparatus 320, the user interface apparatus 340, the user interface apparatus 350, and/or any one or more other portions of the system 300. For example, in some embodiments, the tracking application 337 is configured to receive information associated with one or more payments, where the one or more payments are associated with the debtor 319, from the trustee 317 via the user interface apparatus 340. As another example, in some embodiments, the tracking application 337 is configured to generate and/or communicate one or more notifications to the creditor 315 at the user interface apparatus 340 that indicate, for example, that information associated with one or more payments has been received, that the one or more payments have been applied to debt associated with the debtor 319, that an upcoming payment due date is approaching, and/or the like. It will be further understood that, in some embodiments, the tracking application 337 includes computer-executable program code portions for instructing the processor 334 to perform any one or more of the functions of the tracking application 337 described and/or contemplated herein. In some embodiments, the tracking application 337 may include and/or use one or more network and/or system communication protocols.

In addition to the tracking application 337, the memory 336 also includes the tracking datastore 338. In some embodiments, the tracking datastore 338 includes information associated with one or more bankruptcy cases, including, for example, information associated with the persons and/or entities associated with the bankruptcy cases (e.g., names, addresses, account numbers, etc.), debt associated with the bankruptcy cases (e.g., pre-petition debt, post-petition debt, stipulated agreement debt, etc.), and/or any other type and/or amount of information associated with bankruptcy. In some embodiments, the tracking datastore 338 also stores information associated with receiving payment information, making debt determinations, and/or posting payment application information and/or debt information to a network-accessible account. In some embodiments, the tracking datastore 338 stores financial account information, including, for example, one or more routing numbers, account numbers, account names, payment information, debt information, and/or the like. In some embodiments, the tracking datastore 338 additionally or alternatively stores information associated with online banking In addition, in some embodiments, the tracking datastore 338 additionally or alternatively stores information associated with one or more network-accessible account, including, for example, information associated with the network-accessible account 311.

It will be understood that the tracking datastore 338 may include any one or more storage devices, including, but not limited to, datastores, databases, and/or any of the other storage devices typically associated with a computer system. It will also be understood that the tracking datastore 338 may store information in any known way, such as, for example, by using one or more computer codes and/or languages, alphanumeric character strings, data sets, figures, tables, charts, links, documents, and/or the like. Further, in some embodiments, the tracking datastore 338 may include information associated with one or more applications, such as, for example, the tracking application 337. It will also be understood that, in some embodiments, the tracking datastore 338 provides a substantially real-time representation of the information stored therein, so that, for example, when the processor 334 accesses the tracking datastore 338, the information stored therein is current or substantially current.

Of course, it will be understood that FIG. 3 illustrates an exemplary embodiment of the present invention and that other embodiments may be different. For example, in some embodiments, some or all of the portions of the system 300 may be combined into a single portion. Specifically, in some embodiments, the user interface apparatus 320 and the tracking apparatus 330 are combined into a single user interface and tracking apparatus configured to perform all of the same functions of those separate portions as described and/or contemplated herein. Likewise, in some embodiments, some or all of the portions of the system 300 may be separated into two or more distinct portions. Specifically, in some embodiments, the tracking apparatus 330 may be separated into a payment processing apparatus configured to receive, apply, and/or otherwise process payments, and a payment and debt tracking apparatus configured to track information associated with those payments and the debt to which those payments are applied. As another example, in some embodiments, the system 300 is configured for use only as an internal system by, for example, a financial institution. In such embodiments, the network 310 may include an intranet to which the user interface apparatus 340, the trustee 317, the user interface apparatus 350, and the debtor 319 would not have access. Thus, in such embodiments, only the creditor 315 and/or an employee and/or agent of the creditor 315 would be able to access, via the user interface apparatus 320, the payment and debt information stored in the tracking apparatus 330.

In addition, the various portions of the system 300 may be maintained for by the same or separate entities. For example, as mentioned above, a single financial institution may maintain the user interface apparatus 320 and the tracking apparatus 330. However, in other embodiments, each of these items may be maintained by separate entities. For example, in some embodiments, a service provider (not shown) maintains the tracking apparatus 330, the creditor 315 maintains the user interface apparatus 320, the trustee 317 maintains the user interface apparatus 340, and the debtor 319 maintains the user interface apparatus 350.

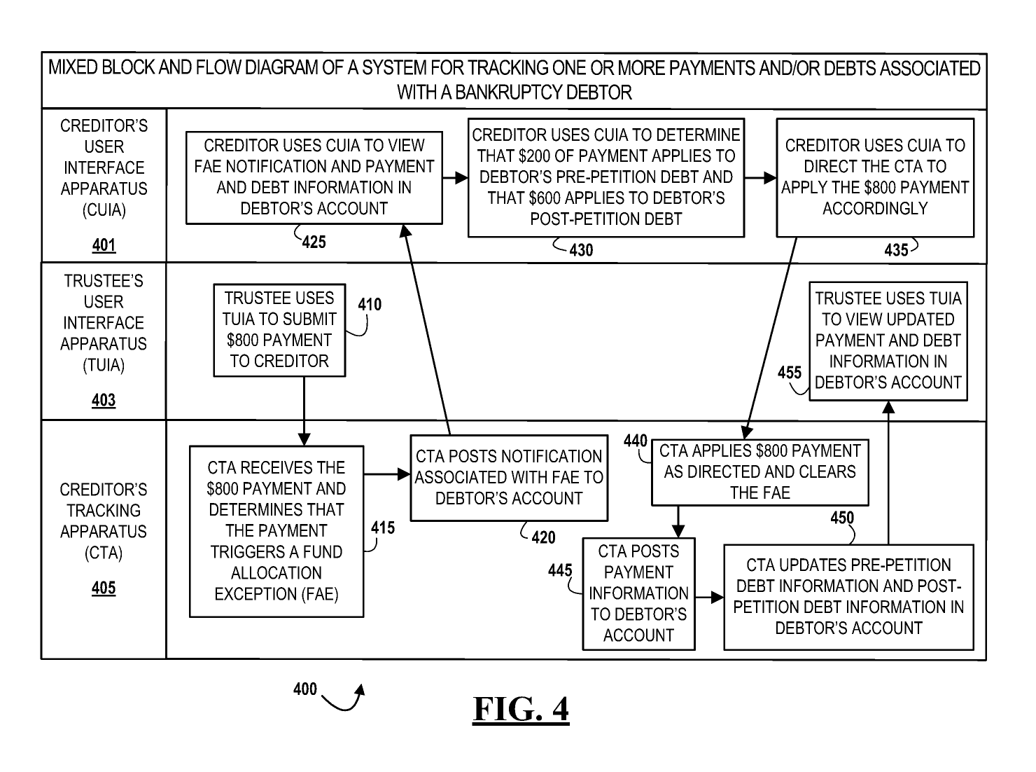

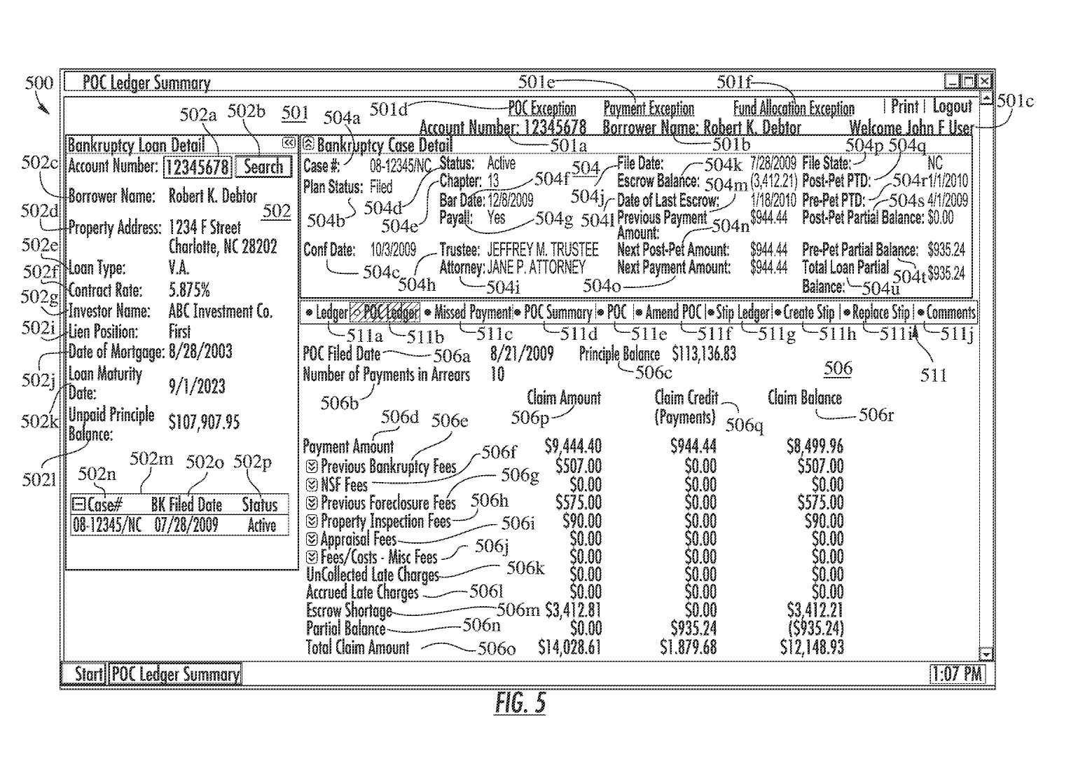

It will also be understood that any one or more of the portions of the system 300 may include and/or implement any one or more portions of any one or more embodiments of the present invention described and/or contemplated herein. For example, in some embodiments, one or more of the portions of the system 300 are configured to include and/or implement any one or more portions of the process flow 100 described and/or contemplated herein in connection with FIG. 1, any one or more portions of the process flow 200 described and/or contemplated herein in connection with FIG. 2, any one or more portions of the process flow 400 described and/or contemplated herein in connection with FIG. 4, and/or any one or more portions of the embodiments described and/or contemplated herein in connection with FIGS. 5-7.

As a specific example, in some embodiments, the tracking apparatus 330 is configured such that: (a) the communication interface 332 of the tracking apparatus 330 is configured to receive information associated with one or more payments, where those one or more payments are associated with the debtor 319, as represented by the block 110 in FIG. 1; and (b) the tracking application 337 is configured to cause the processor 334 of the tracking apparatus 330 to: (i) determine that a first portion of the one or more payments applies to pre-petition debt associated with the debtor 319, as represented by the block 120; (ii) determine that a second portion of the one or more payments applies to post-petition debt associated with the debtor 319, as represented by the block 130; (iii) determine that a third portion of the one or more payments applies to stipulated agreement debt associated with the debtor 319, as represented by the block 140; and (iv) post, to the network-accessible account 311, information that indicates that the first portion applies to the pre-petition debt, information that indicates that the second portion applies to the post-petition debt, and information that indicates that the third portion applies to the stipulated agreement debt, as represented by the block 150.

Referring now to FIG. 4, a mixed block and flow diagram of a system 400 for tracking payments and debts associated with a bankruptcy debtor is provided, in accordance with a more-detailed embodiment of the present invention. As shown, the system 400 includes a user interface apparatus 401 that is accessible to and maintained by a creditor (e.g., the user interface apparatus 320 in FIG. 3, etc.), a user interface apparatus 403 that is accessible to and maintained by a trustee (e.g., the user interface apparatus 340 in FIG. 3, etc.), and a tracking apparatus 405 that is maintained by the creditor (e.g., the tracking apparatus 330 in FIG. 3, etc.). It will be understood that the creditor's user interface apparatus 401 and the trustee's user interface apparatus 403 are both operatively and selectively connected to the creditor's tracking apparatus 405 via a network (not shown).

In this embodiment, it will also be understood that the debtor has filed for bankruptcy protection under Chapter 13, that the bankruptcy case associated with the debtor is a payall case, that the debtor owes the creditor both pre-petition debt and post-petition debt, and that the trustee is associated with the debtor's bankruptcy case and is responsible for collecting money from the debtor and making both pre-petition and post-petition payments to the creditor. It will also be understood that the creditor maintains a network-accessible account associated with the debtor (e.g., the network-accessible account 311 in FIG. 3, etc.) for tracking payments and debts associated with the debtor, and that the creditor provides the trustee with access to the network-accessible account for viewing, communicating, and accessing payment information, debt information, bankruptcy case information, and/or other information associated with the debtor.

As represented by the block 410, the trustee uses the user interface apparatus 403 to submit an $800 payment to the creditor at the creditor's tracking apparatus 405. Then, as represented by the block 415, the tracking apparatus 405 is configured to receive the $800 payment and determine that the payment triggers a fund allocation exception. Next, as represented by the block 420, the tracking apparatus 405 is configured to post a notification associated with the fund allocation exception to the network-accessible account associated with the debtor.

As represented by the block 425, after the fund allocation exception notification is posted to the debtor's account, the creditor uses the user interface apparatus 401 to view the fund allocation exception notification, as well as the payment information, debt information, and/or any other information posted, stored, and/or otherwise included in the debtor's account. Then, as represented by the block 430, the creditor uses the user interface apparatus 401 to determine that $200 of the $800 payment applies to the debtor's pre-petition debt and that the remaining $600 of the $800 payment applies to the debtor's post-petition debt. Thereafter, as represented by the block 435, the creditor uses the user interface apparatus 401 to direct the tracking apparatus 402, via one or more user inputs, to apply the $800 payment in accordance with the creditor's determinations.

As represented by the block 440, the tracking apparatus 405 is configured to receive the one or more user inputs from the creditor's user interface apparatus 401, and then based at least partially on those one or more user inputs, apply the $800 payment to the debtor's pre-petition debt and post-petition debt as directed, as well as clear the fund allocation exception notification from the debtor's account. Thereafter, as represented by the block 445, the tracking apparatus 405 is configured to post information associated with the $800 payment to the debtor's account, and, as represented by the block 450, update the pre-petition debt information and the post-petition debt information (e.g., determine the pre-petition debt PTD, post-petition debt PTD, and/or the remaining balances for the pre-petition debt and post-petition debt as a result of applying the $800 payment, etc.) in the debtor's account. Afterwards, as represented by the block 455, the trustee may use the user interface apparatus 403 to view the posted payment information and the updated debt information in the debtor's account.

It will be understood that, in accordance with some embodiments, the tracking apparatus 405 is configured to perform each of the portions 415-420 and/or each of the portions 440-450 in substantially real time simultaneously, nearly simultaneously, and/or one after the other. It will also be understood that one or more of the portions of the process flow represented by the blocks 410-455 may be automatically triggered by one or more of the other portions represented by the blocks 410-455. It will further be understood that the embodiment illustrated in FIG. 4 and described herein represents a more-detailed embodiment of the present invention and that other embodiments of the present invention may vary. For example, other embodiments of the present invention may include more, fewer, and/or different types of apparatuses and/or devices. In addition, it will be understood that the order, the number, and/or the content of the portions described in FIG. 4 may be different in other embodiments. It will also be understood that the system 400 may, where possible, include and/or implement any other embodiment of the present invention as described and/or contemplated herein. Likewise, any other embodiment of the present invention described and/or contemplated herein may, where possible, be configured to implement one or more of the portions 405-455.

Referring now to FIGS. 5-7, a series of exemplary browser pages 500-700 that display information from a network-accessible account associated with a bankruptcy debtor are provided, in accordance with an embodiment of the present invention. It will be understood that, in this embodiment, the debtor is a home mortgage loan borrower, the borrower has incurred pre-petition debt that includes missed mortgage payments associated with a home mortgage loan, and the borrower incurs post-petition debt that includes ongoing mortgage payments associated with the home mortgage loan. It will also be understood that, in this embodiment, the user interface apparatus 320 described above and illustrated in FIG. 3 is configured to display the browser pages 500-700 at the user interface 329. As such, the borrower's home mortgage loan lender (i.e., the creditor 315) can use the browser application 327 of the user interface apparatus 320 to view the browser pages 500-700 at the user interface 329 and to communicate with the tracking apparatus 330 (e.g., sending one or more user inputs to the tracking apparatus 330 via the browser pages 500-700, etc.). It will also be understood that each of the browser pages 500-700 is configured to navigate to each of the other browser pages 500-700, and/or vice versa. For example, in some embodiments, the browser page 500 is configured to navigate to and/or from the browser page 700. It will further be understood that the browser pages 500-700 can be embodied as Internet web pages, intranet pages, portions of a dashboard user interface, and/or the like.

Referring now to FIG. 5, the browser page 500 provides information associated with the borrower, the borrower's bankruptcy case, the home mortgage loan affected by the bankruptcy case, and the proof of claim that outlines the borrower's pre-petition debt. This information is divided into four major sections: a header section 501, a bankruptcy loan detail section 502, a bankruptcy case detail section 504, and a proof of claim ledger section 506. It will be understood that the header section 501, the bankruptcy loan detail section 502, and the bankruptcy case detail section 504 shown in the browser page 500 are also shown in the browser pages 600-700. It will also be understood, however, that each of the browser pages 500-700 displays information that is different from the other browser pages 500-700. For example, the browser page 500 displays the proof of claim ledger section 506, whereas the browser page 600 displays a detail ledger section 507, and whereas the browser page 700 displays a comment section 508. As described in more detail herein, these different sections correspond to the tabs 511a-511j located in the tab bar 511.

The header section 501 includes the mortgage loan account number 501a, the name of the borrower 501b, and the name of the user 501c (e.g., the user of the user interface 329 that displays the browser page 500, etc.). As shown by the exemplary information provided in FIG. 5, the mortgage loan account number 501a is 12345678, the name of the borrower 501b is Robert K. Debtor, and the name of the user 501c is John F. User. The header section 501 also includes a proof of claim (POC) exception link 501d, a payment exception link 501e, and a fund allocation exception link 501f. It will be understood that the user may select one of the exception links 501d-501f in order to navigate to one or more other browser pages (not shown) that display information associated with the corresponding exception and/or enable the user to provide one or more user inputs regarding the corresponding exception to the tracking apparatus 330. Also, in some embodiments, the user may select one of the exception links 501d-501f in order to navigate to the browser page 800 shown in FIG. 8 that displays one or more comments regarding the corresponding exception.

The bankruptcy loan detail section 502 provides information associated with the home mortgage loan that is associated with the borrower's bankruptcy case. As shown, the bankruptcy loan detail section 502 includes a mortgage loan account number field 502a and corresponding search button 502b, as well as the name of the borrower 502c, the subject property address 502d, the home mortgage loan type 502e, the loan contract rate 502f, the loan investor's name 502g, the lender's and/or investor's lien position on the loan 502i, the date of the loan 502j, the loan maturity date 502k, and the current unpaid principal balance on the loan 502l. As shown by the exemplary information provided in FIG. 5, the name of the borrower 502c is, as mentioned previously, Robert K. Debtor, the subject property address 502d is 1234 F Street, Charlotte, N.C. 28202, the home mortgage loan type 502e is a Veteran's Affairs (V.A.) loan, the loan contract rate 502f is 5.875%, the loan investor's name 502g is ABC Investment Co., the lien position on the loan 502i is first, the date of the home mortgage loan 502j is Sep. 28, 2003, the home mortgage loan maturity date 502k is Sep. 1, 2023, and the current unpaid principal balance on the home mortgage loan 502l is $107,907.95. The bankruptcy loan detail section 502 also includes the bankruptcy case snapshot 502m, which includes the borrower's bankruptcy case number 502n, the bankruptcy case filed date 502o, and the bankruptcy case status 502p. As shown by the exemplary information provided in FIG. 5, the borrower's bankruptcy case number 502n is 08-12345/NC, the bankruptcy case filed date 502o is Jul. 28, 2009, and the bankruptcy case status 502p is active.

The bankruptcy case detail section 504 provides information associated with the bankruptcy case associated with the borrower. As shown, the bankruptcy case detail section 504 includes the bankruptcy case number 504a, the bankruptcy plan status 504b, the meeting of the creditors conference date 504c, the bankruptcy case status 504d, the bankruptcy case chapter number 504e, the proof of claim bar date 504f, the payall status of the bankruptcy case 504g, the name of the trustee associated with the bankruptcy case 504h, the name of the attorney associated with the bankruptcy case 504i, the bankruptcy filing date 504j, the current escrow balance amount 504k, the date of the last escrow 504l, the previous payment amount 504m, the next post-petition amount due 504n, the next payment amount due 504o, the bankruptcy filing state 504p, the post-petition debt PTD 504q, the pre-petition debt PTD 504r, the current post-petition partial account balance 504s, the current pre-petition debt partial account balance 504t, and the current total partial account balance 504u.

As shown by the exemplary information provided in FIG. 5, the bankruptcy case number 504a is 08-12345/NC, the bankruptcy plan status 504b is filed, the meeting of the creditors conference date 504c is Oct. 3, 2009, the bankruptcy case status 504d is active, the bankruptcy case chapter number 504e is Chapter 13, the proof of claim bar date 504f is Dec. 8, 2009, the payall status of the bankruptcy case 504g is yes (i.e., the bankruptcy case is a payall case), the name of the trustee associated with the bankruptcy case 504h is Jeffrey M. Trustee, the name of the attorney associated with the bankruptcy case 504i is Jane P. Attorney, the bankruptcy filing date 504j is Jul. 28, 2009, the current escrow balance amount 504k is −$3,412.21, the date of the last escrow 504l is Jan. 18, 2010, the previous payment amount 504m is $944.44, the next post-petition amount due 504n is $944.44, the next payment amount due 504o is $944.44, the bankruptcy filing state 504p is North Carolina, the post-petition debt PTD 504q is Jan. 1, 2010, the pre-petition debt PTD 504r is Apr. 1, 2009, the current post-petition partial account balance 504s is $0.00, the current pre-petition debt partial account balance 504t is $935.24, and the current total partial account balance 504u is $935.24 (i.e., $0.00+$935.24=$935.24).

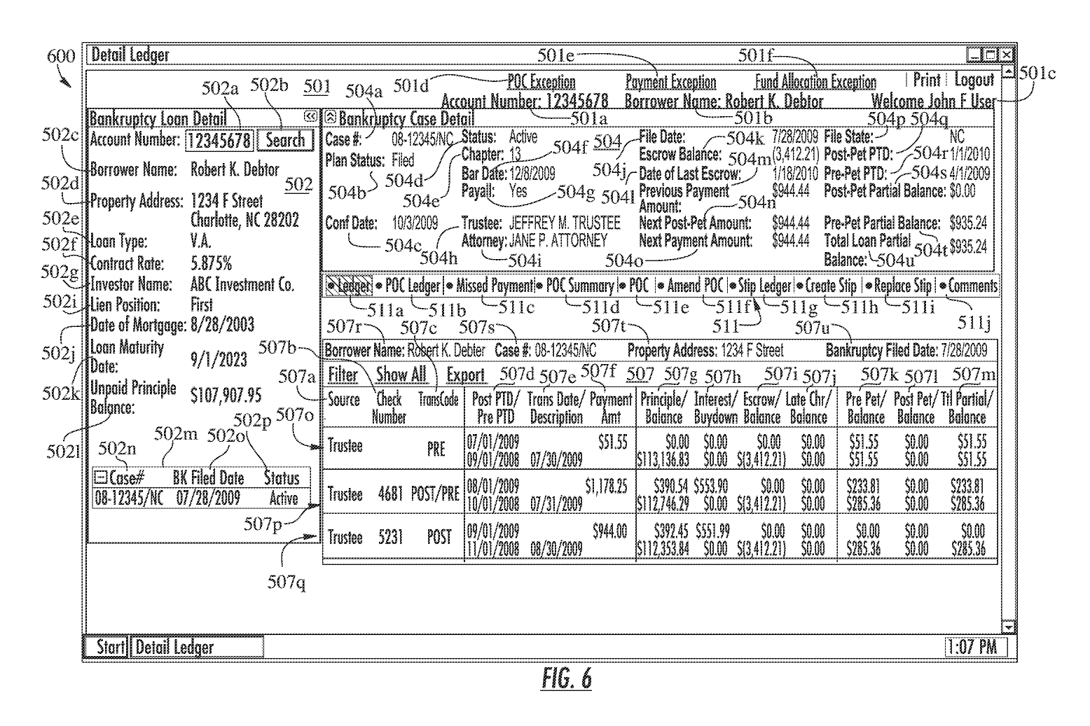

FIG. 5 also includes the tab bar 511 that, in the browser page 500, is positioned between the bankruptcy case detail section 504 and the proof of claim ledger section 506. The tab bar 511 includes a ledger tab 511a, a POC ledger tab 511b, a missed payment tab 511c, a POC summary tab 511d, a POC tab 511e, an amend POC tab 511f, a stipulated agreement debt ledger tab 511g, a create a stipulated agreement debt ledger tab 511h, a replace a stipulated agreement debt ledger tab 511i, and a comment tab 511j. It will be understood that each tab in the tab bar 511 can be embodied as a selectable link and/or button in the browser page 500 and that each tab corresponds to a different set of information that is displayed in the graphical user interface. For example, in the browser page 500, the POC ledger tab 511b is selected, such that information associated with that tab is shown in the proof of claim ledger section 506. However, in the browser page 600 shown in FIG. 6, the ledger tab 511a is selected, such that information associated with that tab is shown in the ledger section 507, which is the same space where the proof of claim ledger section 506 was in the browser page 500 shown in FIG. 5.

The browser page 500 shown in FIG. 5 further includes the proof of claim ledger section 506, which provides information associated with the proof of claim filed by the creditor in connection with the bankruptcy case. As shown, the proof of claim ledger section 506 includes the proof of claim filing date 506a, the number of payments in arrears 506b (i.e., the number of missed mortgage payments prior the bankruptcy filing date), and the principal balance of the home mortgage loan on the date the borrower filed for bankruptcy 506c. As shown by the exemplary information provided in FIG. 5, the proof of claim filing date 506a is Aug. 21, 2009, the number of payments in arrears 506b is 10, and the principal balance of the home mortgage loan on the date the borrower filed for bankruptcy 506c is $113,136.83.

The proof of claim ledger section 506 also includes several rows and columns that provide detailed information about pre-petition debt that was included in the proof of claim and information about any payments since made on that pre-petition debt. More specifically, the proof of claim ledger section 506 includes a payment amount row 506d, a previous bankruptcy fees row 506e, a non-sufficient funds (NSF) fees row 506f, a previous foreclosure fees row 506g, a property inspection fees row 506h, an appraisal fees row 506i, a fee/costs—miscellaneous fees row 506j, an uncollected late charges row 506k, an accrued late charges row 506l, an escrow shortage row 506m, a pre-petition debt partial account balance row 506n, and a total claim amount row 506o. It will be understood that each of these rows (except for the partial balance 506n) represents a different type of debt incurred by the borrower, associated with the borrower, and/or associated with the borrower's home mortgage loan at the time the borrower filed for bankruptcy. The actual amounts for each of these rows (sometimes also referred to herein as “line items”), as they appeared on the proof of claim when it was filed, are shown in the claim amount column 506p. More specifically, as shown by the exemplary information provided in FIG. 5, the claim amount column 506p indicates that the pre-petition debt claimed by the creditor in the proof of claim includes a payment amount 506d of $9,444.40 (i.e., ten missed mortgage payments at $944.44 per payment), $507.00 in previous bankruptcy fees 506e, $575.00 in previous foreclosure fees 506g, $90.00 in property inspection fees 506h, and $3,412.21 in escrow shortage 506m, for a total claim amount 506o of $14,028.61.

Shown alongside the claim amount column 506p in the browser page 500 is the claim credit (payments) column 506q. This column shows the one or more payments made on each of the line items in the proof of claim since the bankruptcy petition was filed. For example, as shown by the exemplary information provided in FIG. 5, since the bankruptcy petition was filed, $944.44 was applied to the payment amount, and $935.24 was applied to the pre-petition debt partial account balance. Thus, a total of $1,879.68 has been applied to the total claim amount since the bankruptcy petition was filed.

In addition, the browser page 500 also displays a claim balance column 506r that is positioned alongside the claim credit (payments) column 506q. This column shows the remaining balance of each of the line items in the proof of claim after deducting each of the payments shown in the claim credit (payments) column 506q. For example, as shown by the exemplary information provided in FIG. 5, the payment amount row 506d passing through the columns 506p, 506q, and 506r indicates that: (a) the payment amount was $9,444.40 at the time the bankruptcy petition was filed; (b) a $944.44 payment has been made on that payment amount since the petition was filed; and (c) the current remaining balance of the payment amount is $8,499.96.

It will be understood that the Jan. 1, 2010, post-petition debt PTD 504q shown in the bankruptcy case detail section 504 is nine months ahead of the Apr. 1, 2009, pre-petition PTD 504r, which indicates that the borrower is current on his post-petition mortgage payments through Jan. 1, 2010, but still has not yet repaid nine of the ten missed mortgage payments incurred prior to filing for bankruptcy. It will also be understood that this conclusion is supported by the information displayed in the payment amount row 506d and the claim credit (payments) column 506q of the POC ledger section 506, which shows $944.44 (i.e., the amount of a single mortgage payment) applied to the $9,444.40 total payment amount (i.e., the amount of ten missed mortgage payments). It will further be understood that a total of $935.24 has been applied to the pre-petition debt partial account balance 504t, and that this amount has not been applied to any of the line items listed in the proof of claim ledger section 506 because, for example, the $935.24 amount in the pre-petition debt partial account balance 504t is not enough to cure one of the borrower's $944.40 pre-petition mortgage payments.

Referring now to FIG. 6, the browser page 600 includes the same account information displayed in the header section 501, the bankruptcy loan detail section 502, and the bankruptcy case detail section 504 of the browser page 500. However, instead of the proof of claim ledger section 506 shown in the browser page 500, the browser page 600 displays a ledger section 507 that includes information associated with one or more payments applied to the pre-petition debt and/or post-petition debt associated with the borrower. As mentioned previously, in accordance with some embodiments, the browser page 600 displays the information associated with the ledger section 507 in response to the user selecting the ledger tab 511a.

As shown in FIG. 6, the information in the ledger section 507 is divided into a number of rows and columns. Each row in the ledger section 507 represents a single transaction that affects the pre-petition debt and/or post-petition debt associated with the borrower, and each column in the ledger section 507 represents one or more details associated with each of those transactions. More specifically, the ledger section 507 includes a source column 507a, a check number column 507b, a transaction code column 507c, a post-petition debt PTD/pre-petition debt PTD column 507d, a transaction date/description column 507e, a payment amount column 507f, a principal payment/balance column 507g, an interest payment/buydown column 507h, an escrow payment/balance column 507i, a late charge payment/balance column 507j, a pre-petition debt partial account payment/balance column 507k, a post-petition debt partial account payment/balance column 507l, and a total partial account payment/balance column 507m.

The ledger section 507 also includes a first transaction row 507o, a second transaction row 507p, and a third transaction row 507q that lists three exemplary transactions associated with the borrower. It will be understood that these three exemplary transactions occurred near the time the borrower filed for bankruptcy and are not necessarily the three most recent transactions listed in the network-accessible account. In addition, it will be understood that, unlike the information provided in the bankruptcy loan detail section 502 and the bankruptcy case detail section 504, which is current or substantially current information, the information provided in each transaction row of the ledger section 507 provides information that was current at the time of the corresponding transaction.

As shown by the exemplary information provided in the first transaction row 507o, the first transaction occurred on Jul. 30, 2009 (which was just after the Jul. 28, 2009, bankruptcy filing date) and involved receiving a $51.55 payment from the trustee and applying that payment to the borrower's pre-petition debt. More specifically, the information provided in the pre-petition debt partial account payment/balance column 507k and in the total partial account payment/balance column 507m indicates that the $51.55 payment was applied to the pre-petition debt partial account balance, thereby making the total partial account balance $51.55. In addition, the information provided in the post-petition debt PTD/pre-petition debt PTD column 507d indicates that, after the July 30 transaction, the borrower's post-petition debt PTD was Jul. 1, 2009, and the borrower's pre-petition debt PTD was Sep. 1, 2008. In addition, the information provided in the transaction code column 507c indicates that the $51.55 payment applies (and was applied) to the pre-petition debt associated with the borrower. Also, the information provided in the principal payment/balance column 507g indicates that, after the July 30 transaction, the principal balance on the borrower's home mortgage loan was $113,136.83. Further, the information provided in the escrow payment/balance column 507i indicates that, after the July 30 transaction, the escrow balance associated with the borrower was −$3,412.21.

As shown by the exemplary information provided in the second transaction row 507p, the second transaction occurred on Jul. 31, 2009, and involved receiving a payment of $1,178.25 from the trustee and applying a portion of that payment to the borrower's post-petition debt and a portion to the borrower's pre-petition debt. More specifically, as shown by the information provided in the principal payment/balance column 507g and in the interest payment/buydown column 507h, $390.54 of the $1,178.25 payment was applied to the principal associated with the home mortgage loan, and $553.90 of the $1,178.25 payment was applied to the interest associated with the home mortgage loan. It will be understood that these principal and interest payment amounts represent the application of a single $944.44 post-petition mortgage payment (i.e., $390.54+$553.90=$944.44) being applied to the home mortgage loan. This is reflected by the information provided in the post-petition debt PTD/pre-petition debt PTD column 507d, which indicates that, as a result of applying part of the July 31 received payment to the principal and interest of the home mortgage loan, the post-petition debt PTD was Aug. 1, 2009, and the pre-petition debt PTD was Oct. 1, 2008. These dates indicate that, as a result of the July 31 transaction, the borrower was current on his post-petition mortgage payments through Aug. 1, 2009, but still had not yet repaid the ten missed mortgage payments incurred prior to filing for bankruptcy.

In addition, the information provided in the pre-petition debt partial account payment/balance column 507k and in the total partial account payment/balance column 507m indicates that the remaining $233.81 of the $1,178.25 payment was applied to the pre-petition debt partial account balance, thereby making the total partial account balance $285.36 (i.e., $51.55+$233.81=$285.36). It will be understood that, in accordance with some embodiments, the $233.81 amount represents the quotient of the total original claim amount of $14,028.61 shown in the browser page 500 divided by sixty payments (i.e., equal monthly payments spread over a five year Chapter 13 plan period). Further, the information provided in the transaction code column 507c indicates that the $1,178.25 payment applies (and was applied) to both the pre-petition debt and post-petition debt associated with the borrower. In addition, the information provided in the principal payment/balance column 507g indicates that, as a result of applying the $390.54 principal payment, the principal balance on the borrower's home mortgage loan was $112,746.29 (i.e., $113,136.83−$390.54=$112,746.29). Further, the information provided in the escrow payment/balance column 507i indicates that, as a result of the July 31 transaction, the escrow balance associated with the borrower was still −$3,412.21. Still further, the information provided in the source column 507a and in the check number column 507b indicates that the $1,178.25 payment was received from the trustee in the form of a check and that the check number was 468l.

As shown by the exemplary information provided in the third transaction row 507q, the third transaction occurred on Aug. 30, 2009, and involved receiving a payment amount of $944.44 from the trustee and applying that payment to the borrower's post-petition debt. As shown by the information provided in the principal payment/balance column 507g and in the interest payment/buydown column 507h, $392.45 of the $944.44 payment was applied to the principal associated with the home mortgage loan, and $551.99 of the $944.44 payment was applied to the interest associated with the home mortgage loan. It will be understood that these principal and interest payment amounts represent the application of a single $944.44 post-petition mortgage payment (i.e., $392.45+$551.99=$944.44) being applied to the home mortgage loan. This is reflected by the information shown in the post-petition debt PTD/pre-petition debt PTD column 507d, which indicates that, as a result of applying the August 30 post-petition mortgage payment to the home mortgage loan, the post-petition debt PTD was Sep. 1, 2009, and the pre-petition debt PTD was Nov. 1, 2008. These dates indicate that, as a result of the August 30 transaction, the borrower was current on his post-petition mortgage payments through Sep. 1, 2009, but still had not yet repaid the ten missed mortgage payments incurred prior to filing for bankruptcy.

In addition, the information provided in the third transaction row 507q indicates that, after the August 30 transaction, the pre-petition debt partial account balance and the total partial account balance were each still $285.36. Further, the information provided in the transaction code column 507c indicates that the $944.44 payment applies (and was applied) to post-petition debt associated with the borrower. In addition, the information provided in the principal/balance column 507g indicates that, as a result of applying the $392.45 principal payment, the principal balance on the borrower's home mortgage loan was $112,353.84 (i.e., $112,746.29−$392.45=$112,353.84). Further, the information provided in the escrow/balance column 507i indicates that, after the August 30 transaction, the escrow balance associated with the borrower was still −$3,412.21. Still further, the information provided in the source column 507a and in the check number column 507b indicates that the $944.44 payment was received from the trustee in the form of a check and that the check number was 5231.

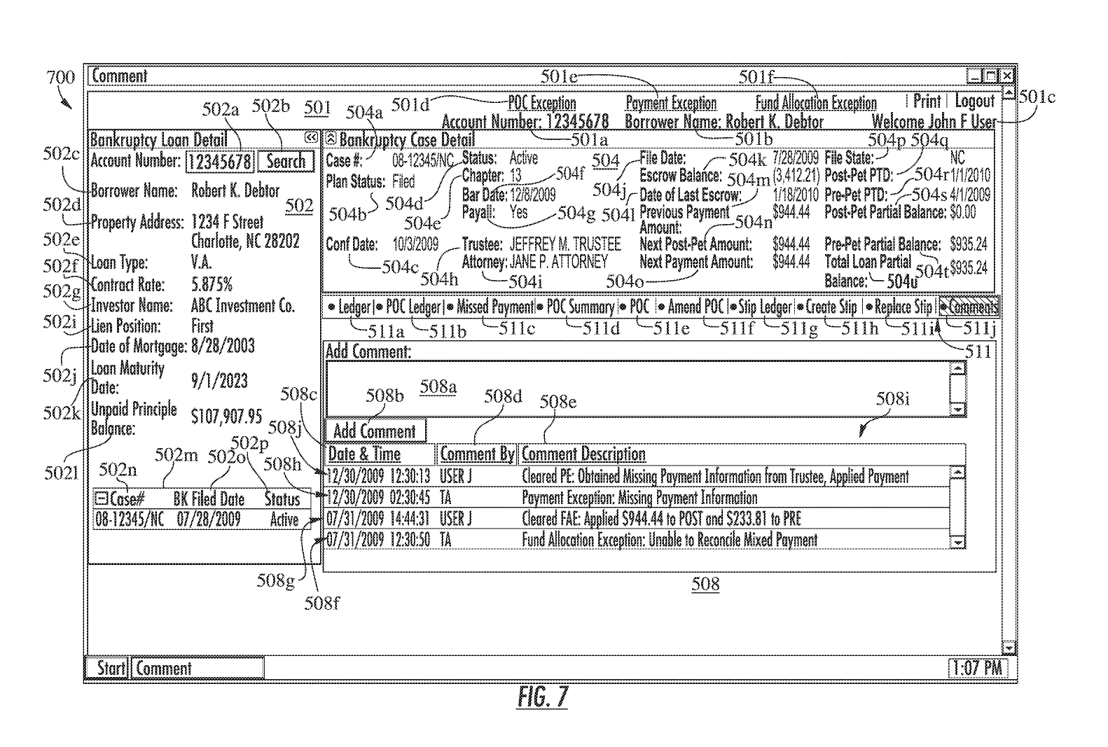

Referring now to FIG. 7, the browser page 700 includes the same account information displayed in the header section 501, the bankruptcy loan detail section 502, and the bankruptcy case detail section 504 of the browser page 500. However, instead of the proof of claim ledger section 506 shown in the browser page 500, the browser page 700 displays a comment section 508 that displays information associated with one or more user-generated and/or apparatus-generated comments associated with the network-accessible account. As mentioned previously, in accordance with some embodiments, the browser page 700 displays the information associated with the comment section 508 in response to the user selecting the comment tab 511j.

As shown in FIG. 7, the comment section 508 includes an add comment field 508a and an add comment button 508b. The comment section 508 also includes a comment ledger 508i that includes information that is divided into a number of rows and columns. Each row in the comment ledger 508i represents a single comment, and each column in the comment ledger 508i represents one or more details associated with each of those comments. More specifically, the comment ledger 508i includes a date and time column 508c, a comment by column 508d, and a comment description column 508e. The comment ledger 508i also lists four exemplary comments that are displayed in a first comment row 508f, a second comment row 508g, a third comment row 508h, and a fourth comment row 508j.

As shown by the exemplary information provided in the first comment row 508f, the first comment was generated on Jul. 31, 2009, at approximately 12:30 pm by TA (i.e., the tracking apparatus 330) and describes a fund allocation exception triggered by a mixed payment that the tracking apparatus 330 was unable to reconcile. It will be understood that this comment corresponds to the Jul. 31, 2009, payment described in the second transaction row 507p shown in the browser page 600. More specifically, the tracking apparatus 330 was unable to determine how to apply the Jul. 31, 2009, payment of $1,178.25, so the apparatus generated a fund allocation exception regarding the payment and posted a notification associated with that fund allocation exception to the comment section 508 of the browser page 700.

As shown by the exemplary information provided in the second comment row 507g, the second comment was generated on Jul. 31, 2009, at approximately 2:44 pm by USERJ (i.e., the user, John F. User) and describes the clearing of the fund allocation exception triggered by the Jul. 31, 2009, payment referred to in the first comment row 508f. More specifically, the second comment describes how the user directed the tracking apparatus 330 (e.g., via the browser page 500, etc.) to apply $944.44 of the $1,178.25 payment to the post-petition debt associated with the borrower, apply $233.81 to the pre-petition debt associated with the borrower, and clear the fund allocation exception. It will be understood that, in accordance with some embodiments, the user can select the fund allocation exception link 501f to access one or more other browser pages (not shown) where the user can direct the tracking apparatus 330 to take one or more actions regarding the borrower's account, including, for example, applying a payment, clearing an exception, and/or the like. It will also be understood that the user can generate a comment, such as the second comment described in the second comment row 507g, by using the add comment field 508a and the add comment button 508b.

As shown by the exemplary information provided in the third comment row 508h, the third comment was generated on Dec. 30, 2009, at approximately 2:30 am by the tracking apparatus 330 and describes a payment exception triggered by missing payment information. More specifically, the tracking apparatus 330 was unable to apply a payment received on Dec. 30, 2009 (not described in the other browser pages 500 or 600) because the payment was missing critical information (e.g., the drawer's signature, date of the check, account number, etc.). Thus, the tracking apparatus 330 generated a payment exception regarding the payment and posted a notification associated with the payment exception to the comment section 508 of the browser page 700.

As shown by the exemplary information provided in the fourth comment row 508j, the fourth comment was generated on Dec. 30, 2009, at approximately 12:30 pm by the user and describes the clearing of the payment exception triggered by the Dec. 30, 2009, payment referred to in the third comment row 508h. More specifically, the fourth comment describes how the user obtained the missing payment information from the trustee and directed the tracking apparatus 330 to apply the payment to at least one of the borrower's pre-petition debt or post-petition debt. It will be understood that, in accordance with some embodiments, the user can select the payment exception link 501e to access one or more other browser pages (not shown) where the user can direct the apparatus to take one or more actions regarding the borrower's account, including, for example, applying a payment, clearing an exception, and/or the like. It will also be understood that the user can generate a comment, such as the fourth comment described in the fourth comment row 508j, by using the add comment field 508a and the add comment button 508b.

It will be understood that the creditor 315 can use the browser application 327 of the user interface apparatus 320 to view one or more other browser pages (not shown) that correspond to the missed payment tab 511c, the POC summary tab 511d, the POC tab 511e, the amend POC tab 511f, the stipulated agreement debt ledger tab 511g, the create a stipulated agreement debt ledger tab 511h, the replace a stipulated agreement debt ledger tab 511i, and/or the POC exception link 501d. For example, in accordance with some embodiments, the creditor 315 can select the POC exception link 501d in order to view information associated with a proof of claim exception and/or direct the tracking apparatus 330 to take one or more actions relating thereto. As another example, in accordance with some embodiments, the creditor 315 can select the missed payment tab 511c in order to view information associated with the borrower's missed mortgage payments prior to the borrower filing for bankruptcy protection. As a further example, in accordance with some embodiments, if the borrower falls behind on his post-petition mortgage payments, such that the borrower and the creditor agree to a stipulated agreement, then the creditor 315 could select the stipulated agreement debt ledger tab 511g in order to view information associated with stipulated agreement debt (e.g., the amount of the stipulated agreement debt, the repayment schedule associated with the stipulated agreement debt, one or more payments made on the stipulated agreement debt, etc.).

As still another example, in accordance with some embodiments, the creditor 315 can access one or more browser pages associated with the POC tab 511e, amend POC tab 511f, create a stipulated agreement debt ledger tab 511h, and/or replace a stipulated agreement debt ledger tab 511i in order to communicate one or more user inputs to the tracking apparatus 330 regarding the proof of claim associated with the borrower and/or the stipulated agreement debt associated with the borrower. In some embodiments, the creditor 315 may access these one or more browser pages in order to direct the tracking apparatus 330 to generate the proof of claim and/or generate the stipulated agreement based at least partially on the one or more user inputs provided by the creditor 315 to the tracking apparatus 330. In still other embodiments, the creditor 315 may access these one or more browser pages in order to communicate, to the tracking apparatus 330, one or more user inputs regarding information associated with the proof of claim and/or information associated with the stipulated agreement debt, so that such information may be used by the tracking application 337 and/or stored in the tracking datastore 338.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, combinations, and modifications of the just described embodiments can be configured without departing from the scope and spirit of the invention. Therefore, it is to be understood that, within the scope of the appended claims, the invention may be practiced other than as specifically described herein.

What is claimed is:

1. A method comprising:
receiving information associated with one or more payments, wherein the one or more payments are associated with a debtor;
determining, using a processor, that a first portion of the one or more payments applies to pre-petition debt associated with the debtor;
determining, using a processor, that a second portion of the one or more payments applies to post-petition debt associated with the debtor; and
posting, to a network-accessible account associated with the debtor, information that indicates that the first portion applies to the pre-petition debt and information that indicates that the second portion applies to the post-petition debt.

2. The method of claim 1, further comprising:
applying, using a processor, the first portion to the pre-petition debt; and
applying, using a processor, the second portion to the post-petition debt.

3. The method of claim 1, wherein determining that the first portion applies to the pre-petition debt comprises:
determining, using a processor, that the first portion applies to the pre-petition debt based at least partially on a determination that the first portion was received from a trustee.

4. The method of claim 1, wherein determining that the second portion applies to the post-petition debt comprises:
determining, using a processor, that the second portion applies to the post-petition debt based at least partially on a determination that the second portion was received from the debtor.

5. The method of claim 1, further comprising:
determining, using a processor, that a third portion of the one or more payments applies to stipulated agreement debt associated with the debtor; and
posting, to the network-accessible account, information that indicates that the third portion applies to the stipulated agreement debt.

6. The method of claim 5, further comprising:
applying, using a processor, the third portion to the stipulated agreement debt.

7. The method of claim 1, further comprising:
posting, to the network-accessible account, information associated with a proof of claim associated with the debtor.

8. The method of claim 1, further comprising:
generating, using a processor, a proof of claim for a bankruptcy case associated with the debtor; and
transmitting, using a communication interface, the proof of claim to an attorney for filing with a court.

9. The method of claim 1, further comprising:
determining, using a processor, that at least one payment from the one or more payments triggers a fund allocation exception; and
posting, to the network-accessible account, information associated with the fund allocation exception.

10. The method of claim 9, further comprising:
receiving, from the network-accessible account, one or more user inputs regarding the fund allocation exception; and
applying, using a processor and based at least partially on the one or more user inputs, the at least one payment to at least one of the pre-petition debt or the post-petition debt.

11. The method of claim 1, further comprising:
determining, using a processor, that at least one payment from the one or more payments triggers a payment exception; and
posting, to the network-accessible account, information associated with the payment exception.

12. The method of claim 11, further comprising:
receiving, from the network-accessible account, one or more user inputs regarding the payment exception; and
applying, using a processor and based at least partially on the one or more user inputs, the at least one payment to at least one of the pre-petition debt or the post-petition debt.

13. The method of claim 1, wherein determining that the first portion applies to the pre-petition debt further comprises:
determining, using a processor, that the first portion applies to the pre-petition debt based at least partially on one or more user inputs.

14. The method of claim 1, wherein determining that the second portion applies to the post-petition debt further comprises:
determining, using a processor, that the second portion applies to the post-petition debt based at least partially on one or more business rules.

15. The method of claim 1, further comprising:
determining, using a processor, a pre-petition debt paid through date (PTD) as a result of applying the first portion to the pre-petition debt;
determining, using a processor, a post-petition debt PTD as a result of applying the second portion to the post-petition debt; and
posting, to the network-accessible account, information associated with the pre-petition debt PTD and information associated with the post-petition debt PTD.

16. The method of claim 1, further comprising:
determining, using a processor, a remaining balance of the pre-petition debt as result of applying the first portion to the pre-petition debt; and
posting, to the network-accessible account, information associated with the remaining balance of the pre-petition debt.

17. A system comprising:
a tracking apparatus comprising:
a communication interface configured to receive information associated with one or more payments, wherein the one or more payments are associated with a bankruptcy debtor; and
a processor operatively connected to the communication device and configured to:
determine that a first portion of the one or more payments applies to pre-petition debt associated with the debtor; and
determine that a second portion of the one or more payments applies to post-petition debt associated with the debtor; and
a user interface apparatus operatively connected to the tracking apparatus and comprising:
a user interface configured to display information that indicates that the first portion applies to the pre-petition debt and information that indicates that the second portion applies to the post-petition debt.

18. The system of claim 17, wherein the processor is further configured to post, to a network-accessible account associated with the debtor, information that indicates that the first portion applies to the pre-petition debt and information that indicates that the second portion applies to the post-petition debt, and wherein the user interface apparatus is further configured to access the network-accessible account to display, at the user interface, the information that indicates that the first portion applies to the pre-petition debt and the information that indicates that the second portion applies to the post-petition debt.

19. The system of claim 17, wherein the processor is further configured to:
apply the first portion to the pre-petition debt; and
apply the second portion to the post-petition debt.

20. The system of claim 17, wherein the processor is configured to determine that the first portion applies to the pre-petition debt based at least partially on a determination that the first portion was received from a trustee.

21. The system of claim 17, wherein the processor is configured to determine that the second portion applies to the post-petition debt based at least partially on a determination that the second portion was received from the debtor.

22. The system of claim 17, wherein the processor is further configured to determine that a third portion of the one or more payments applies to stipulated agreement debt associated with the debtor, and wherein the user interface apparatus is further configured to display, at the user interface, information that indicates that the third portion applies to the stipulated agreement debt.

23. The system of claim 22, wherein the processor is further configured to apply the third portion to the stipulated agreement debt.

24. The system of claim 17, wherein the user interface apparatus is configured to display, at the user interface, information associated with a proof of claim associated with the debtor.

25. The system of claim 17, wherein the processor is further configured to generate a proof of claim for a bankruptcy case associated with the debtor, and wherein the communication interface is further configured to transmit the proof of claim to an attorney for filing with a court.

26. The system of claim 17, wherein the processor is further configured to determine that at least one payment from the one or more payments triggers a fund allocation exception, and wherein the user interface apparatus is further configured to display, at the user interface, information associated with the fund allocation exception.

27. The system of claim 26, wherein the communication interface is further configured to receive, from the user interface apparatus, one or more user inputs regarding the fund allocation exception, and wherein the processor is further configured to apply, based at least partially on the one or more user inputs, the at least one payment to at least one of the pre-petition debt or the post-petition debt.

28. The system of claim 17, wherein the processor is further configured to determine that at least one payment from the one or more payments triggers a payment exception, wherein the user interface apparatus is further configured to display, at the user interface, information associated with a network-accessible account associated with the debtor, and wherein the information associated with the network-accessible account comprises information associated with the payment exception.

29. The system of claim 28, wherein the communication interface is further configured to receive, from the user interface apparatus, one or more user inputs regarding the payment exception, and wherein the processor is further configured to apply the at least one payment to at least one of the pre-petition debt or the post-petition debt.

30. The system of claim 17, wherein the processor is further configured to determine a pre-petition debt PTD as a result of applying the first portion to the pre-petition debt, wherein the processor is further configured to determine a post-petition debt PTD as a result of applying the second portion to the post-petition debt, and wherein the user interface apparatus is further configured to display, at the user interface, information associated with the pre-petition debt PTD and information associated with the post-petition debt PTD.

31. The system of claim 17, wherein the processor is further configured to determine a remaining balance of the pre-petition debt as result of applying the first portion to the pre-petition debt, and wherein the user interface apparatus is further configured to display, at the user interface, information associated with the remaining balance of the pre-petition debt.

32. A computer program product comprising a non-transitory computer-readable medium, wherein the computer-readable medium comprises computer-executable program code portions stored therein, wherein the computer-executable program code portions comprise:
a first program code portion configured to determine that a first portion of one or more payments applies to pre-petition debt associated with a debtor;
a second program code portion configured to determine that a second portion of the one or more payments applies to post-petition debt associated with the debtor; and
a third program code portion configured to post, to a network-accessible account associated with the debtor, information that indicates that the first portion applies to the pre-petition debt and information that indicates that the second portion applies to the post-petition debt.

33. The computer program product of claim 32, further comprising:
a fourth program code portion configured to determine that a third portion of the one or more payments applies to stipulated agreement debt associated with the debtor; and
a fifth program code portion configured to post, to the network-accessible account, information that indicates that the third portion applies to the stipulated agreement debt.

34. The computer program product of claim 32, further comprising:
a fourth program code portion configured to determine that at least one payment from the one or more payments triggers fund allocation exception; and
a fifth program code portion configured to post, to the network-accessible account, information associated with the fund allocation exception.

35. The computer program product of claim 32, further comprising:
a fourth program code portion configured to determine that at least one payment from the one or more payments triggers a payment exception; and
a fifth program code portion configured to post, to the network-accessible account, information associated with the payment exception.

36. The computer program product of claim 32, further comprising:
a fourth program code portion configured to determine a pre-petition debt PTD as a result of applying the first portion to the pre-petition debt;
a fifth program code portion configured to determine a post-petition debt PTD as a result of applying the second portion to the post-petition debt; and
a sixth program code portion configured to post, to the network-accessible account, information associated with the pre-petition debt PTD and information associated with the post-petition debt PTD.
